(19) United States
(12) Patent Application Publication
(10) Pub. No.: US 2025/0290630 A1
(43) Pub. Date: Sep. 18, 2025

(54) JOINT SEAL SYSTEM & METHOD

(71) Applicant: The Schebler Co., Bettendorf, IA (US)

(72) Inventors: Bradley Zogg, Blue Grass, IA (US); David Bruggeman, Matherville, IL (US); Al Landwher, Sheffield, IL (US); Jason Heinz, Davenport, IA (US); Matt Anderson, St. Augusta, MN (US); David Wagner, Davenport, IA (US); Kelsey Shindelar, Camanche, IA (US); Noah Monigold, Moline, IL (US)

(73) Assignee: The Schebler Co., Bettendorf, IA (US)

(21) Appl. No.: 19/223,014

(22) Filed: May 29, 2025

Related U.S. Application Data
(63) Continuation of application No. 17/677,706, filed on Feb. 22, 2022, now abandoned.

(51) Int. Cl. F23J 13/04; F16L 23/032; F16L 23/08; F16L 23/10; F16L 23/12; F16L 23/16; F16L 23/20; F16L 27/12; F23J 13/02

(52) U.S. Cl. CPC F23J 13/04; F16L 23/032; F16L 23/08; F16L 23/10; F16L 23/12; F16L 23/162; F16L 23/20; F16L 27/12; F23J 13/02; F23J 13/025; F23J 2213/202; F23J 2213/204; Y10T 29/53

(57) ABSTRACT

A joint seal system and method may be configured to mitigate and/or eliminate leakage of pressure, flue gases, condensate, helium vent gas and/or any other fluid, gas, and/or vapor between abutting flanges of duct sections at a flange interface. A weld-free MRI machine quench vent discharge system using pre-fabricated chimney duct components may be configured by selecting a quench vent outlet and discharge location, mapping a route, and determining directional changes. Elbows and bellows sections are selected based on these changes, and the distance between the MRI machine and discharge location is calculated to determine support positions. The system is assembled using prefabricated chimney ducts, each comprising an inner shell with spinner bolt flanges and a leak-free joint with a PTFE gasket. The design includes an outer shell with an insulation gap for thermal protection.

### CROSS REFERENCE TO RELATED APPLICATIONS

This non-provisional utility patent application is a continuation-in-part of and claims priority from U.S. patent application Ser. No. 18/657,756 filed on May 7, 2024 which is a continuation of and claims priority from U.S. patent application Ser. No. 17/677,706 filed on Feb. 22, 2022 (now abandoned) which was a continuation of and claimed priority from U.S. patent application Ser. No. 16/268,228 filed on Feb. 5, 2019 (now U.S. Pat. No. 11,255,541) which application claimed priority from provisional U.S. Pat. App. No. 62/626,605 filed on Feb. 5, 2018 and was a continuation-in-part of and also claimed priority from nonprovisional U.S. patent application Ser. No. 15/359,045 filed on Nov. 22, 2016 (now U.S. Pat. No. 10,731,781), which application claimed priority from provisional U.S. Pat. App. No. 62/258,511 filed on Nov. 22, 2015. This non-provisional patent application also claims priority from provisional patent App. Nos. 63/652,677 and 63/774,056 filed on May 29, 2024 and Mar. 18, 2025, respectively. All of the preceding applications are incorporated by reference herein in their entireties.

### FIELD OF INVENTION

The present invention relates to duct work for handling various types of gases. More particularly, the present invention is especially useful in providing an air-tight joint between two duct sections. The present disclosure also relates to a method of configuring and assembling a weld-free MRI machine quench vent system using pre-fabricated chimney duct components.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### BACKGROUND

Double-walled chimneys are known in the art, one example of which is disclosed in the U.S. Pat. No. 3,902,744 to Stone and prior art cited therein. The basic construction involves inner and outer concentric pipes affording an annular insulating space between them. Fundamentally, the assembly or erection of the chimney proceeds with coaxial, end-to-end stacking of, say, a pair of inner pipes, the meeting ends of which are radially outwardly flanged to receive an inner annular ring which clamps the pipes together.

Another example of a double-walled chimney is disclosed in U.S. Pat. No. 4,724,750, which is incorporated by reference herein. These and other prior art references show that it is known in the art to fabricate corresponding flanges on two adjacent sections at the interface thereof. The flanges are typically transverse to the basic axis of the chimney section. Typically an annular ring is placed over the junction of the two corresponding flanges to better seal the chimney.

Although these flanged chimney sections are well known when the cross-sectional shape of the chimney is circular or angular (such as rectangular, square, etc.), the prior art does not disclose a flanged chimney section or corresponding connection system for chimneys with a cross-sectional area that is rounded but non-circular. One such rounded but non-circular shape is often referred to as “obround.” As used herein, “obround” is defined as a shape consisting of two semicircles connected by parallel lines tangent to their endpoints.

### SUMMARY OF INVENTION

In at least one embodiment, the prefabricated chimney duct is a chimney system useful for critical pressure rated (CPR) quench vent systems for use with MRI machines or systems. As disclosed and configured, chimney system is a pre-engineered bolt-together product that offers cost savings by decreasing on-site fabrication work while providing precision engineered design and reliable construction with factory-assured quality fabrication. The inner shell spinner bolt flange is rotatable and may move axially ensuring easy alignment and connection of adjacent chimney sections. Further, in at least one embodiment, all tube sections may be formed from fully non-magnetic 304 stainless steel, including internal plumbing and the external shrouding. In at least one embodiment hardware, couplers and transitions may be fabricated from all nonmagnetic stainless steel.

In at least one embodiment, cryogenic-rated PTFE gaskets may be used between the bolt-together prefabricated chimney sections to ensure a positive seal and reliable service. In at least one embodiment, cryogenic-rated insulation may be placed in and around the bolt-together prefabricated chimney sections to ensure reliable service and provide personnel protection.

In at least one embodiment of creating a discharge chimney system for an MRI machine quench vent using pre-fabricated chimney duct components without welding is disclosed. In at least one embodiment, the illustrative process may start by selecting the MRI machine quench vent outlet and a discharge location. The method may include mapping a route between these two points and determining if there are any changes in direction, either vertically or horizontally. For each change in direction, at least one elbow can be selected, and if a horizontal change is needed, at least one bellows section may be chosen. The method may also involve calculating the distance between the MRI machine and the discharge location and determining the position for at least one support based on this distance. The method can further include assembling multiple prefabricated chimney ducts to connect according to the mapped route between the MRI machine quench vent outlet and the discharge location. This assembly may follow the selection and mapping process described in the first claim.

In at least one embodiment, each prefabricated chimney duct section may include a first inner shell with a first end configured with an inner shell rim and a second end also configured with an inner shell rim. The body portion of the inner shell can connect these ends. The section may also have a first inner shell spinner bolt flange configured as a collar to surround the exterior of the first inner shell, with apertures positioned around its perimeter. This flange can contact and abut the inner shell rim at the first end. Similarly, a second inner shell spinner bolt flange may be configured to surround the exterior of the inner shell and contact the inner shell rim at the second end. In at least one embodiment, a leak-free joint is created by positioning and connecting adjacent prefabricated chimney duct sections. This leak-free joint can include a gasket positioned between the second inner shell spinner bolt flange of a first prefabricated chimney duct section and the abutting first inner shell spinner bolt flange of a second section. The gasket may have apertures around its perimeter and be made of polytretrafluoroethylene (PTFE), suitable for temperatures ranging from −452.4 degrees F. to 100 degrees F. A plurality of fasteners can be inserted through the aligned apertures of the gasket and the flanges to secure the connection of the adjacent sections.

In at least one embodiment, the prefabricated chimney duct section may also include a tubular outer shell surrounding the inner shell. An L-shaped clip can be positioned between the inner and outer shells to create an insulation gap, where insulating material may be placed.

At least one embodiment of a weld-free MRI machine quench vent system assembled from pre-fabricated vent duct components is illustrated. A quench vent outlet extending from an MRI machine located in a hospital room to a vent discharge location exterior to the hospital room that allows safe discharge of quench gas is contemplated. A vent route connecting the quench vent outlet to the vent discharge location is disclosed as well as a vent termination selected based on the vent discharge location and the vent route. A plurality of prefabricated vent duct sections may be configured with vent flanges and connected to fluidly connect the quench vent outlet to the vent termination according to the generated vent route, wherein the prefabricated vent duct sections are subjected to high-pressure, low temperature conditions.

At least one embodiment contemplates a plurality of vent supports positioned along the vent duct based on a calculated vent route distance.

At least one embodiment contemplates at least one vent elbow required for each change in direction of the vent route.

At least one embodiment contemplates one vent bellows required to compensate for thermal contraction in the prefabricated vent duct sections.

At least one embodiment contemplates a system of prefabricated vent duct sections are connected to fluidly connect the quench vent outlet to the vent termination according to the generated vent route.

### BRIEF DESCRIPTION OF THE FIGURES

The accompanying drawings, which are incorporated in and constitute a part of this specification, illustrate embodiments and together with the description, serve to explain the principles of the methods and systems.

FIG. 1 is a perspective view of one chimney section of a first embodiment.

FIG. 2 is a detailed, cross-sectional view of the junction of two adjacent chimney sections according to the first embodiment.

FIG. 3 is a perspective view of two chimney sections of the first embodiment joined to one another with a V-band.

FIG. 4 is an end view of a chimney section of the first embodiment wherein the cross-sectional shape of the chimney section is obround.

FIG. 5 is a detailed, cross-sectional view of the junction of two adjacent chimney sections according to the second embodiment, wherein the chimney system is insulated.

FIG. 6 is a detailed view of the exterior of the chimney at the junction of two sections with a V-band applied thereto.

FIG. 7 is a perspective view of one chimney section of the section embodiment.

FIG. 8 is an elevated view of a sheet of material showing the creases for one embodiment of a chimney section.

FIG. 9A provides a top view of various aspects of a seal that may be used with a joint seal system & method.

FIG. 9B provides a side view of the seal from FIG. 9A.

FIG. 10A provides a top view of a band that may be used with a joint seal system & method.

FIG. 10B provides a side view of the band shown in FIG. 10A.

FIG. 10C provides a cross-sectional view of the band shown in FIGS. 10A & 10B.

FIG. 11 provides a perspective view showing various aspects of a seal positioned on a flange.

FIG. 12A provides a perspective view of a flange interface with a seal positioned between the two flanges and a band positioned over the flange interface.

FIG. 12B provides a perspective view of the flange interface shown in FIG. 12A with an exterior band positioned over the flange interface and band.

FIG. 13 provides a perspective view of an intermediate section with a slip collar positioned between two fixed sections.

FIG. 14 provides a perspective view of the intermediate section and fixed sections from FIG. 13 wherein each fixed section is abutting the intermediate section.

FIG. 15 provides a side view of two chimney sections engaged with one another illustrating at least one embodiment of the joint seal system and method disclosed throughout.

FIG. 15A provides an end view of an insulated chimney section.

FIG. 15AA provides a detailed view of the connection of the two chimney sections of FIG. 15 illustrating at least one embodiment of the joint seal system and method disclosed throughout.

FIG. 16 provides a perspective view of a starter section that may be used with the joint seal system and method.

FIG. 17 provides a side view of two chimney sections engaged with one another illustrating at least one embodiment of the quench vent joint seal system and method disclosed throughout.

FIG. 17A provides an end view of an insulated chimney section of FIG. 17.

FIG. 17AA provides a detailed view of the connection of the two chimney sections of FIG. 17 illustrating at least one embodiment of the quench vent joint seal system and method disclosed throughout.

FIG. 17B provides an exploded view of the two chimney sections of FIG. 17.

FIG. 18 illustrates the inner shell rim and inner shell spinner bolt flange interface.

FIG. 18A illustrates the inner shell spinner flange partially disassembled from inner shell rim.

FIG. 19 illustrates an embodiment of the quench vent joint seal system and method as a single wall chimney system assembled from multiple sections prior to installation of insulation.

FIG. 20 is a flow chart useful for a method of configuring and assembling a quench vent system comprised of prefabricated chimney duct sections for various routes and terminations.

FIG. 21 is a perspective view of an illustrative quench vent system comprised of prefabricated chimney duct sections illustrating multiple changes in direction and with a capped roof termination at a discharge location on the top of a roof.

FIG. 21A is a side view of the illustrative quench vent system comprised of prefabricated chimney duct sections disclosed at FIG. 21.

FIG. 21B is a detailed side view of a capped roof termination.

FIG. 22 is a side view of at least one embodiment of a bellows section which may be incorporated into an MRI quench vent system as disclosed herein.

FIG. 22A is a perspective view of at least one embodiment of a bellows section with tie rods which may be incorporated into an MRI quench vent system as disclosed herein.

FIG. 23 is a perspective view of an illustrative quench vent system comprised of prefabricated chimney duct sections illustrating multiple changes in direction and a discharge cone for the termination exiting through a wall to an exterior area.

FIG. 23A is a side view of the illustrative quench vent system comprised of prefabricated chimney duct sections disclosed at FIG. 23.

FIG. 23B is a detailed side view of a discharge cone as shown in FIGS. 23 and 23A which May be incorporated into an MRI quench system as disclosed herein.

FIG. 24 illustrates another embodiment of a termination for an MRI quench vent system configured as a box discharge.

FIG. 25 is an illustrative perspective view of an MRI machine including the quench vent outlet.

FIG. 26 is a performance graph for low temperature insulation suitable for at least one embodiment of a quench vent joint system using the prefabricated chimney ducts as disclosed herein.

### DETAILED DESCRIPTION-LISTING OF ELEMENTS

| ELEMENT DESCRIPTION | ELEMENT # |
|---|---|
| MRI Machine | 1 |
| MRI Machine quench vent outlet | la |
| Super conducting main magnetic field | 1b |
| Gradient coils | 1c |
| Radiofrequency coil | 1d |
| Patient | 2 |
| Interior space | 3 |
| Exterior space | 4 |
| Roof/ceiling | 5 |
| Wall | 6 |
| Floor | 7 |
| Chimney system | 10 |
| Gasket (high temperature) | 12 |
| Gasket apertures | 12a |
| Gasket (low temperature) | 13 |
| Gasket apertures (low temperature) | 13a |
| First section | 20 |
| First section body | 22 |
| First section body interior | 23a |
| First section body exterior | 23b |
| First section flange | 24 |
| Second section | 30 |
| Second section body | 32 |
| Second section body interior | 33a |
| Second section body exterior | 33b |
| Second section flange | 34 |
| Flange interface | 36 |
| V-band | 40 |
| First flat portion | 42a |
| Second flat portion | 42b |
| First angled portion | 44a |
| Second angled portion | 44b |
| V-band apex | 46 |
| V-band clamp | 48 |
| Insulated chimney system (high temperature) | 50 |
| Insulated chimney section | 51 |
| Starter section | 51' |
| Starter section collar | 51a |
| Insulation | 52 |
| Spacer clip | 53 |
| Spacer clip inner tab | 53a |
| Spacer clip outer tab | 53b |
| Inner shell | 55 |
| Inner shell flange | 55a |
| Inner shell rim | 55b |
| Outer shell | 56 |
| Outer shell channel | 56a |
| Outer band | 57 |
| Inner shell spinner bolt flange | 58 |
| Inner shell spinner bolt flange apertures | 58a |
| Joint seal (leak-free) | 59 |
| Sheet | 60 |
| Sheet right edge | 61a |
| Sheet left edge | 61b |
| Crease | 62 |
| Outer section | 64 |
| Inner section | 66 |
| Middle section | 68 |
| Insulated chimney system (low temperature) | 70 |
| Insulated chimney first section | 71 |
| First section inner shell body | 71a |
| First section inner shell body interior | 71b |
| First section inner shell body exterior | 71c |
| First section inner shell rim | 71d |
| Insulated chimney second section | 72 |
| Second section inner shell body | 72a |
| Second section inner shell body interior | 72b |
| Second section inner shell body exterior | 72c |
| Second section inner shell rim | 72d |
| First section outer shell | 73 |
| First section outer shell - exterior | 73a |
| Second section outer shell | 74 |
| Second section outer shell - exterior | 74a |
| Inner shell spinner bolt flange/inner shell rim interface | 75 |
| Insulation gap | 78 |
| Joint seal (leak-free) low temperature | 79 |
| Insulation | 80 |
| Insulation strip | 81 |
| Band | 110 |
| Hinge | 112 |
| Connector | 114 |
| Anchor | 116 |
| Slot | 116a |
| Angled portion | 117 |
| Vertex | 117a |
| Flat portion | 118 |
| Seal | 120 |
| Exterior band | 130 |
| Intermediate section | 140 |
| Fixed flange | 142 |
| Free end | 143 |
| Slip collar | 144 |
| Slip collar flange | 144a |
| Support | 150 |
| Plate | 151 |
| Hanger | 152 |
| Full rings | 152 |
| Bellows section | 155 |
| Outer skirt of bellows section | 155a |
| Outer circumference bellows section | 155b |
| Elbow section | 160 |
| Termination | 165 |
| Termination - capped roof | 166 |
| Termination - discharge cone | 167 |
| Termination - discharge box | 168 |
| Fasteners (bolts, nuts) | 180 |
| MRI Machine quench vent system | 200 |
| Discharge location | 202 |
| Route (generated) | 204 |
| Change in direction | 206 |
| Elbow position | 208 |
| Bellows position | 210 |
| Distance between MRI Machine and discharge location | 212 |
| Support position | 214 |
| Selection of an MRI machine quench vent outlet | 300 |
| Selection of a discharge location | 302 |
| Mapping route | 304 |
| Determine change in direction | 306 |
| Selection of at least one elbow | 308 |
| Selection of at least one bellows section | 310 |
| Calculate distance between MRI machine and the | 312 |
| discharge location | |
| Determine position of supports | 314 |
| Assemble prefabricated chimney ducts | 316 |

### DETAILED DESCRIPTION

Before the present methods and apparatuses are disclosed and described, it is to be understood that the methods and apparatuses are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of”′ and is not intended to convey an indication of a preferred or ideal embodiment. “Such as” is not used in a restrictive sense, but for explanatory purposes.

Disclosed are components that can be used to perform the disclosed methods and apparatuses. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and apparatuses. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and apparatuses may be understood more readily by reference to the following detailed description of preferred aspects and the examples included therein and to the Figures and their previous and following description. Corresponding terms may be used interchangeably when referring to generalities of configuration and/or corresponding components, aspects, features, functionality, methods and/or materials of construction, etc. those terms.

Before the various aspects of the present disclosure are explained in detail, it is to be understood that the disclosure is not limited in its application to the details of construction and the arrangements of components set forth in the following description or illustrated in the drawings.

The present disclosure is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description, and do not alone indicate or imply that the device or element referred to must have a particular orientation. In addition, terms such as “first”, “second”, and “third” are used herein and in the appended claims for purposes of description and are not intended to indicate or imply relative importance or significance.

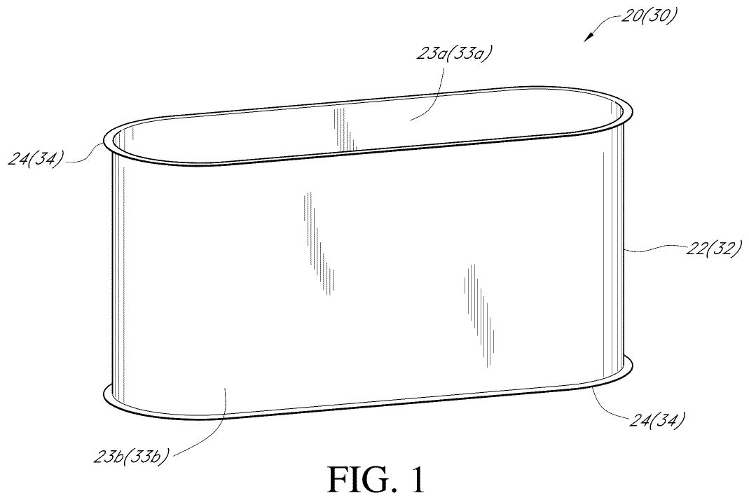

Referring now to the drawings, wherein like reference numerals designate identical or corresponding parts throughout the several views, FIG. 1 illustrates various aspects of a first section 20 of the chimney system 10. The chimney system 10 as disclosed herein may comprise any number of sections 20, 30, but for clarity only two sections 20, 30 (a first section 20 and a second section 30) are discussed and pictured herein. However, the scope of the present disclosure is not so limited unless indicated in the following claims.

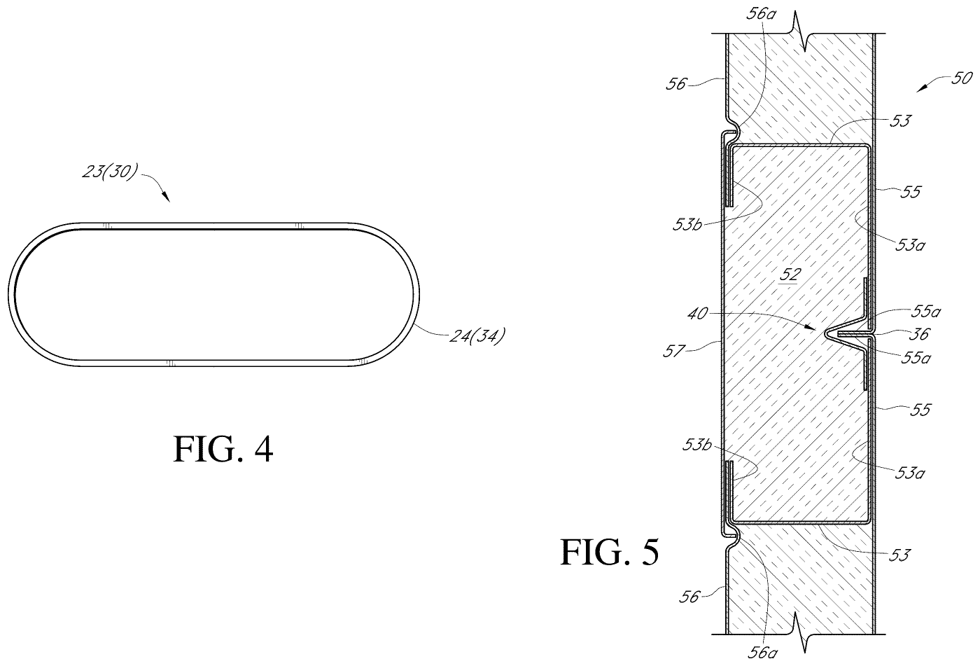

The sections 20, 30 may be obround in shape, which is best shown at least in FIGS. 1 and 4, the latter of which is an end view of a section 20, 30. Each section 20, 30 may include a section body 22, 32. The inner surface of the first section body 22 may be comprised of a first section body interior 23a, and the exterior surface may be comprised of a first section body exterior 23b.

Correspondingly, the inner surface of the second section body 32 may be comprised of a second section body interior 33a, and the exterior surface may be comprised of a second section body exterior 33b. Generally, the fluid routed through the chimney system 10 may pass through the portion of space bounded by the section body interiors 23a, 33a.

Referring still to FIG. 1, the first section 20 may include a first section flange 24 on each end of the first section body 22. Each first section flange 24 may be generally perpendicular to the main longitudinal axis of the first section body 22. Each first section flange 24 may be integrally formed with the first section body 22. In this manner, the entire first section 20 may be formed from one piece of material. The specific dimensions of the first section flange 24 and the orientation thereof with respect to the first section body 22 may vary depending on the specific application for the chimney system 10, and is therefore in no way limiting to the scope of the present disclosure unless so indicated in the following claims. In some applications, it is envisioned that the first section flange 24 may be oriented exactly ninety degrees from the first section body exterior 23b, such that the first section body 22 and the first section flange 24 form a right angle between them, and that the first section flange 24 extend one-half inch from the first section body exterior 23b. The precise angle between the first section flange 24 and first section body exterior 23b will be greater or less than ninety degrees in other aspects of the chimney system 10 without departing from the spirit and scope of the chimney system 10 unless so limited in the following claims. Furthermore, the first section flange 24 may extend from the first section body exterior 23b by an amount greater or less than one-half inch, and is therefore in no way limiting in scope of the present disclosure unless so indicated in the following claims.

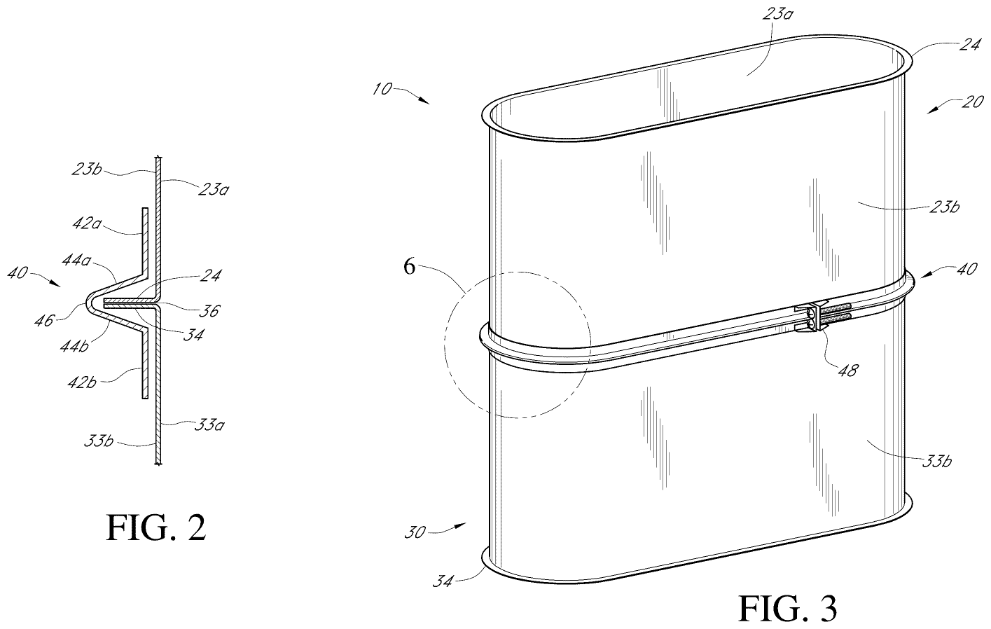

Various aspects of a junction between the first section 20 and the second section 30 is shown in detail in FIG. 2. The cross-sectional view of this junction as shown in FIG. 2 shows the first section flange 24 abutted with the second section flange 34 to form a flange interface 36.

Although not shown in FIG. 2, a sealant (not shown) may be placed at the flange interface 36. In one aspect, first section flange 24 may be perpendicular to the first section body 22 and the second section flange 34 may be perpendicular to the second section body 32 as previously described above. Furthermore, the first section body 22 may be parallel to the second section body 32, and the first section flange 24 may be parallel to the second section flange 34. Because the first and second section flanges 24, 34 may be parallel to one another, the flange interface 36 may include nearly the entire surface area of both the first and second section flanges 24, 34. In many applications this configuration may provide a better seal at the flange interface 36.

In an aspect, a V-band 40 may be placed over the flange interface 36. A V-band 40, as shown in FIG. 2, may include a first flat portion 42a that may abut the first section body exterior 23b and a corresponding second flat portion 42b that may abut the second section body exterior 33b. To ensure the clearance between the respective flat portions 42a, 42b and section body exteriors 23b, 33b is optimal, the V-band 40 may include a V-band clamp 48 for adjusting the tension of the V-band clamp 48. As shown herein, the V-band clamp 48 may be configured as a typical bolt-and-receiver clamp with two bolts. However, the V-band clamp 48 may employ any structure or method suitable for adjusting the tension of banding structures around the exterior of a section 20, 30 without departing from the scope of the present invention unless so indicated in the following claims. The first flat portion 42a may be connected to the first angled portion 44a and the second flat portion 42b may be connected to the second angled portion 44b. The first angled portion 44a and the second angled portion 44b may be connected by the V-band apex 46.

The relative angles and orientations between and among the first flat portion 42a, second flat portion 42b, first angled portion 44a, second angled portion 44b, and V-band apex 46 may be different than those show here in other embodiments without departing from the spirit and scope of the present disclosure unless so indicated in the following claims.

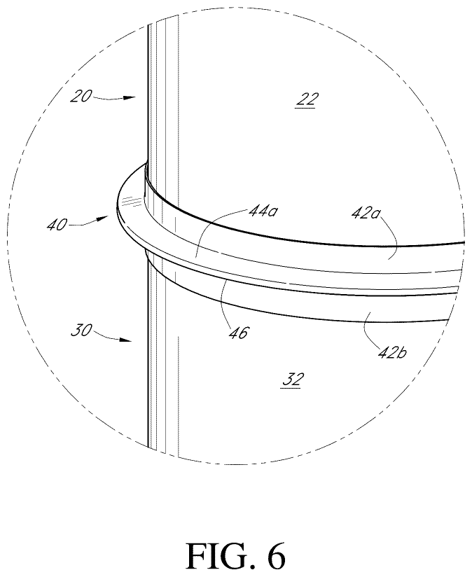

Again, although not shown in FIG. 2, sealant (not shown) may be positioned between the flange interface 36 and any portion of the V-band 40, and/or between the first section body exterior 23b, second section body exterior 33b and the first flat portion 42a or second flat portion 42b. The sealant (not shown) placed in any of the areas listed above may be used to hermetically seal the flange interface 36 and/or the junction of the first and second sections 20, 30. The sealant (not shown) used in any aspect or application of either the chimney system 10 or insulated chimney system 50 (described in detail below) may be any type of sealant (not shown) known to those skilled in the art or later developed that is appropriate for the particular application, whether silicon-based, Teflon-based, or otherwise. For example, S600 or S2000 may be used as a sealant (not shown) to enhance the gas impermeable seal, which may be rated or used with a range of pressures including negative, neutral, or positive pressures greater than one atmosphere (1 ATM). As those of ordinary skill in the art will appreciate, although not shown in the various figures herein, the chimney system 10 and insulated chimney system 50 also may have an insulating material positioned between the V-band 40 and flange interface 36. The junction between a first section 20 and second section 30 is shown in perspective in FIG. 3, and FIG. 6 shows the junction of the first and second section 20, 30 with the V-band 40 applied thereto in greater detail.

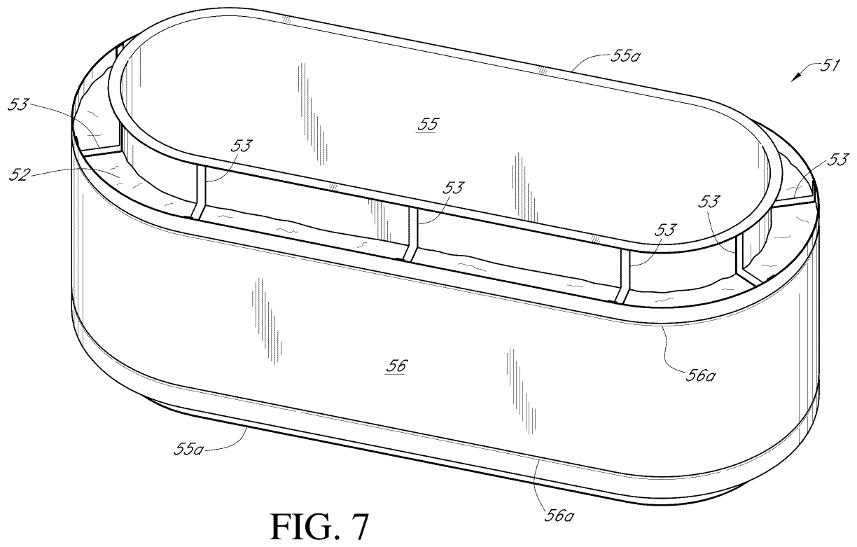

Additional aspects of a chimney system 10 are shown FIG. 5, which provides a cross-sectional view of two insulated chimney sections 51 at a flange interface 36. The flange interface 36 shown in FIG. 5 may be between two adjacent insulated chimney sections 51, which insulated chimney sections 50 may be configured in a manner similar to those shown in FIG. 7. One or more insulated chimney section 51 in cooperation with another fluid conduit may constitute an insulated chimney system 50. In one aspect, an insulated chimney system 50 may include a plurality of insulated chimney sections 51. The inner shell 55 of an insulated chimney section 51 may be substantially the same as the sections 20, 30 of the chimney system 10 described in detail above. Accordingly, the flange interface 36 between the two adjacent inner shells 55 of the insulated chimney system 50 shown in FIG. 5 may be substantially the same as the flange interface 36 between the first section 20 and the second section 30 shown in FIG. 1.

In the insulated chimney system 50 each inner shell 55 and an outer shell 56 may be substantially the same shape for a given insulated chimney section 51, although the periphery of the outer shell 56 generally will be greater than that of the inner shell 55. As previously mentioned, each inner shell 55 of the insulated chimney system 50 may be substantially the same as each section 20, 30 of the chimney system 10 described in detail above in that an inner shell flange 55a May be integrally formed with the inner shell 55 on at least one end of each inner shell 55.

Accordingly, the junction between two adjacent insulated chimney sections 51 at their respective inner shells 55 may form a flange interface 36 substantially similar in structure and function to that described in detail above for the chimney system 10. As described for the flange interface 36 in the chimney system 10, a V-band 40 may be used to secure one inner shell 55 to an adjacent inner shell 55, but the scope of the present disclosure is not so limited unless indicated in the following claims.

In the insulated chimney system 50, a predetermined amount of insulation 52 may be positioned between the inner shell 55 and the outer shell 56. The distance between the inner shell 55 and outer shell 56 may be determined by the length of the spacer clips 53, which spacer clips 53 may extend from the inner shell 55 to the outer shell 56. The spacer clips 53 and insulation 52 may be configured so that an air gap (not shown) remains between the insulation 52 and the outer shell 56 if desired. In another aspect, each spacer clip 53 may include a spacer clip inner tab 53a and spacer clip outer tab 53b. The spacer clip inner tab 53a may be placed between one of the flat portions 42a, 42b of the V-band 40, as shown in FIG. 5, or over one of the flat portions 42a, 42b.

Each spacer clip outer tab 53b may be directly secured to the outer shell 55.

In an aspect shown in FIG. 7, the outer shell 56 may be formed with an outer shell channel 56a therein on at least one end of the outer shell 56. An outer band 57 may be placed between two adjacent outer shells 55. As shown in FIG. 5, the outer band 57 may be configured so that each end of the outer band 57 may seat within the outer shell channel 56a in two adjacent outer shells 56, respectively.

To facilitate access to the inner shells 55 during assembly or for maintenance, adjacent outer shells 56 may be formed with a significant space therebetween, as shown in FIG. 5. As described above, an outer band 57 may be placed between two adjacent outer shells 56 to seal the space between the two outer shells 55. The amount of space between adjacent outer shells 56 (and consequently the dimensions of the outer band 57) will vary depending on the specific application of the insulated chimney system 50, and is therefore in no way limiting to the scope of the present disclosure unless so indicated in the following claims. The inner and outer shells 55, 56 may be connected via one or more spacer clips 53 prior to installation of the insulated chimney system 50, and insulation 52 may be placed between the inner and outer shells 55, 56, allowing corresponding inner and outer shells 55, 56 to be installed as one unit, referred to herein as an insulated chimney section 51. As is apparent to those skilled in the art in light of the present disclosure, both the chimney system 10 and the insulated chimney system 50 of the present disclosure may allow for tension to be applied to either the V-band 40 and/or the outer band 57 in a direction perpendicular to the longitudinal axis of the chimney system 10 or insulated chimney system 50.

In one aspect of the chimney system 10, the first section 20 and second section 30 may both be comprised of twenty gauge 304 stainless steel. In one aspect of the insulated chimney system 50 the inner shell 55 may be comprised of twenty gauge 304 stainless steel. Typically, an insulation layer may be applied. The longitudinal seams for any section 20, 30 of the chimney system 10, or any inner shell 55 or outer shell 56 of the insulated chimney system 50 may be continuously welded to reduce corrosion and ensure a pressure-tight seal at each seam. Those of ordinary skill in the art will appreciate that other structures and/or methods of manufacture are possible, without limitation unless so indicated in the following claims.

The sections 20, 30, V-band 40, V-band clamp 48, spacer clip 53, inner shell 55, and outer shell 56 may be made from twenty gauge 304 stainless steel, higher or lower chrome steels, or any other material known to those skilled in the art or later developed that is suitable for the application. However, the material chosen in no way limits the scope of the present disclosure unless so indicated in the following claims, and it is contemplated that such specifications may vary based on the particular application for which the chimney system 10 or insulated chimney system 50 is used.

As shown in the end view of a section 20, 30 in FIG. 4, in an aspect the cross-sectional shape of each section 20, 30 may be obround. However, the chimney system 10 or insulated chimney system 50 may be configured with sections 20, 30 having cross-sectional shapes of infinite variety as long as the cross-sectional shape is rounded but non-circular. Accordingly, the shape chosen in no way limits the scope of the present invention unless so indicated in the following claims, and it contemplated that such specifications may vary based on the particular application for which the chimney system 10 or insulated chimney system 50 is used.

To better understand the chimney system 10 and insulated chimney system 50, one method of manufacture for a section 20, 30 as pictured and previously described herein will now be described in detail. Those skilled in the art will appreciate that a number of ways to manufacture a section 20, 30 for the chimney system 10 exist, and the specific method used in no way limits the scope of the chimney system 10, sections 20, 30, insulated chimney system 50, or insulated chimney sections 51 unless so indicated in the following claims. Accordingly, the method that follows is but one way to manufacture a chimney section 20, 30.

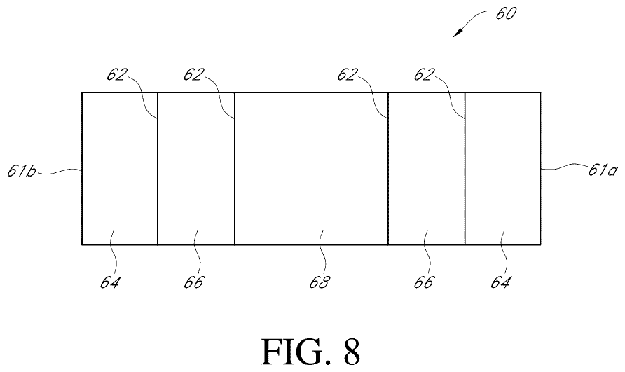

A piece of material, such as stainless steel, may be first cut to the dimensions required to form a sheet 60, which is shown in FIG. 8. Typically, the sheet 60 is rectangular in shape, but it may be other shapes as well. The precise dimensions of the sheet 60 will be dependent on the design specifications for the chimney system 10 or insulated chimney system 50. The sheet 60 is positioned in a metal brake (not shown) and four creases 62 are formed therein. The four creases 62 serve to divide the sheet into five sections. The five sections include two outer sections 64, two inner sections 66, and one middle section 68. One outer section 64 is adjacent the sheet right edge 61a and the other outer section 64 is adjacent the sheet left edge 61b. The middle section 68 is in the geometric center of the sheet 60, and an inner section 66 is positioned on either side thereof. The two outer sections 64 are identical with one another in size and shape, and the two inner sections 66 are identical with one another in size and shape. Accordingly, the creases 62 are symmetrical about both axes of the sheet.

The sheet 60 is then placed on a metal forming roll (not shown). Each outer section 64 is then formed into a quarter-circle shape. Next, the middle section 68 is formed into a half-circle shape.

After this step, the sheet right edge 61a and sheet left edge 61b are in close proximity to one another so that they may be welded together. The resulting seam runs in an axial direction along the entire length of the section 20, 30. In an aspect, the two outer sections 64 cooperate to form one rounded side of the section 20, 30 and the middle section 68 forms the other rounded side.

The two inner sections 66 comprises the straight sides of the section 20, 30.

A rigid jig may then be placed around the outer periphery of the section 20, 30 so that the cross-sectional shape of the section 20, 30 is maintained throughout the remainder of the fabrication process. The section 20, 30 may be positioned on a roll forming machine (not shown) set to form a flange 24, 34 of the desired dimensions at one end of the section 20, 30. If a second flange 24, 34 is desired on the other end of the section 20, 30, the jig may be transferred adjacent that end and a flange 24, 34 may be formed thereon using the roll forming machine (not shown). To ensure that the section 20, 30 remains symmetrical along the longitudinal axis thereof throughout the fabrication process, the rotation of the roll forming machine (not shown) may be reversed during the formation of the second flange 24, 34. That is, if the first flange 24, 34 is formed by rotating the section 20, 30 clockwise in the roll forming machine (not shown), the second flange 24, 34 may be formed by rotating the section 20, 30 counter-clockwise in the roll forming machine (not shown).

The outer shell 56 for an insulated chimney section 51 may be fabricated in substantially the same manner. However, instead of forming a flange 24, 34 on the roll forming machine (not shown), a different die may be used that forms an outer shell channel 56a. As with the fabrication of the section 20, 30, if the outer shell 56a is fabricated with an outer shell channel 56a on each end thereof, the direction of rotation of the outer shell 56 during formation of the first outer shell channel 56a may be opposite of the direction of rotation of the outer shell 56 during formation of the second outer shell channel 56a.

Sections 20, 30 (i.e., inner shells 55 when used in an insulated chimney system 50) may be joined with corresponding outer shells 56 through the use of spacer clips 53, many methods of which are well known to those skilled in the art and will therefore not be described in further detail herein. Insulation 52 may also be placed between the inner shell 55 and outer shell 56 so that each insulated chimney section 50 is ready to install before it is exposed to the elements.

It is contemplated that machines other than those described for use in the above method may be used to fabricate sections 20, 30, inner shells 55, outer shells 56, or insulated chimney sections 51. Accordingly, the specific machine used to fabricate any element of the chimney system 10 or insulated chimney system 50 in no way limits the scope of the present disclosure unless so indicated in the following claims.

### DETAILED DESCRIPTION OF A JOINT SEAL SYSTEM & METHOD

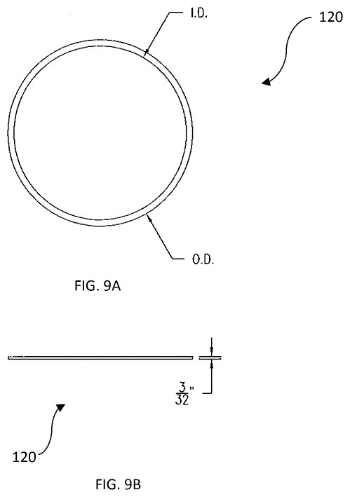

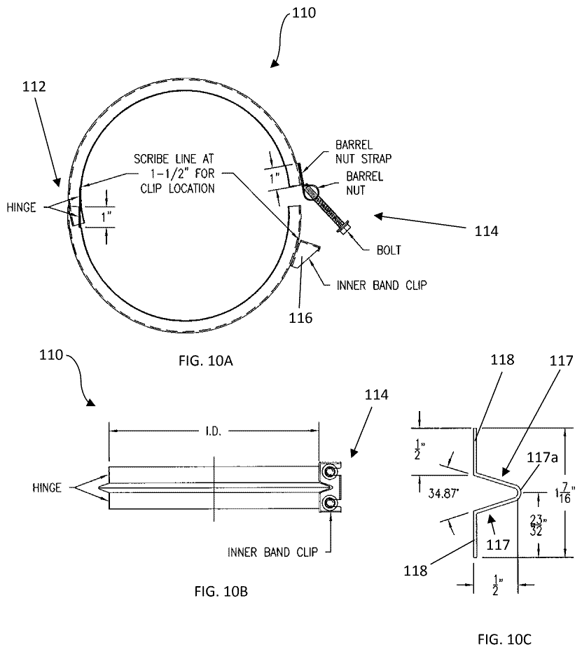

Various aspects of a seal 120 are shown in FIG. 9, which may comprise a portion of a joint seal system & method. Various aspects of a band 110 that may be employed with a seal 120 are shown in FIG. 10, which together with a seal 120 may comprise a joint seal system & method. In both FIGS. 9 & 10 various dimensions and/or relative shapes of certain aspects of the band 110 and seal 120 are shown. Such dimensions and/or relative shapes are for illustrative purposes only, and in no way limit the scope of the joint seal system & method unless so indicated in the following claims.

It is contemplated that in an aspect, a joint seal system & method according to the present disclosure may be especially useful when employed with a high-efficiency, commercial boiler vent, wherein a joint seal system & method may be configured to hold pressure in a fluid conduit in order to mitigate and/or eliminate leakage of condensate, flue gasses, and/or other fluid, vapor, and/or gas from a joint between two duct sections (e.g., a flange interface 36) and/or between two sections 20, 30 of a chimney system 10 and/or insulated chimney system 50. Accordingly, it is contemplated that certain aspects of a joint seal system & method may be especially useful at a flange interface 36 of two sections 20, 30 (either insulated or not) having flanges 24, 34, such as those shown in FIGS. 1-7.

In an aspect, the joint seal system & method may be configured for use with any gas fired appliance listed as Category II, III, or IV or that call for an AL 29-4C vent. Generally, when describing the joint seal system & method below, any section 20, 30 and/or flange 24, 34 may refer to an uninsulated section 20, 30 or any insulated section 51 without limitation unless so indicated. It is contemplated that the joint seal system & method, in conjunction with one or more sections 20, 30, may be installed as a complete system connecting a device (e.g., an appliance) to the outdoors while operating under positive forced draft, negative induced draft, or neutral gravity flow internal pressuring conditions. In applications in which a drain fitting May be required, it is contemplated that it may be advantageous to locate the drain fitting as close to the flue outlet as is possible, but other locations may be used without limitation unless so indicated in the following claims. Installation instructions and an operation and maintenance manual illustrating various aspects of a joint seal system & method is attached hereto and made a part hereof as Appendix A.

Referring now to FIGS. 10A-10C, a band 110 may generally be configured as a ring and comprising a hinge 112, which hinge 112 may be opposite two open ends of the band 110. In an aspect, a connector 114 may be engaged with a first open end and an anchor 116 engaged with a second open end as further described in detail below. In other aspects, a band 110 may be differently shaped without limitation unless so indicated in the following claims. For example, in an aspect a band 110 may have an obround shape for use with a section 20, 30 such as that shown in FIGS. 1-7. A connector 114 may be formed as a bolt that is configured to engage an anchor 116 at the two free ends of the band 110, respectively. In this manner, the band 110 May be configured to allow relatively easy engagement and disengagement with one or more sections 20, 30 at a flange interface 36. Other connectors 114 may be used with a joint seal system & method without limitation unless so indicated in the following claims, and the optimal structure and/or method for a connector 114 will vary from one application of the joint seal method & system to the next.

The band 110 may be configured with two angled portions 117 extending from a vertex 117a to form a V-shape in cross section. At the end of each angled portion 117 opposite the vertex 117a, a flat portion 118 may extend away from a line bisecting the two angled portions 117. In an aspect, the cross-sectional shape of the band 110 may be symmetrical, as shown in FIG. 10A or FIG. 10C. In certain applications, it is contemplated that it may be advantageous to configure the band 110 such that each flat portion 118 is between 0.25 and 1.0 inches, with an especially advantageous dimension of 0.5 inches. Additionally, it is contemplated that for certain applications it may be advantageous to configure the band 110 such that the linear dimension from the vertex 117a to each flat portion 118 is between 0.25 and 1.0 inches, with an especially advantageous dimension of 0.5 inches. Finally, it is also contemplated that for certain applications it may be advantageous to configure the vertex 117a and two angled portions 117 such that the angle between the two angled portions is between 60 and 80 degrees, with an especially advantageous angle of 70 degrees. Accordingly, the overall distance between the distal end of one flat portion 118 and that of the other flat portion 118 may be between 1.0 and 2.25 inches, with an especially advantageous distance of about 1 and 7/16th inches. In one aspect, it is contemplated that the band 110 may be constructed from 22 gauge metallic material, and May further be constructed of 304, 316, or 316L stainless steel. However, other suitable material and/or other relative dimensions, configurations, etc. of the various elements may be used without limitation unless so indicated in the following claims.

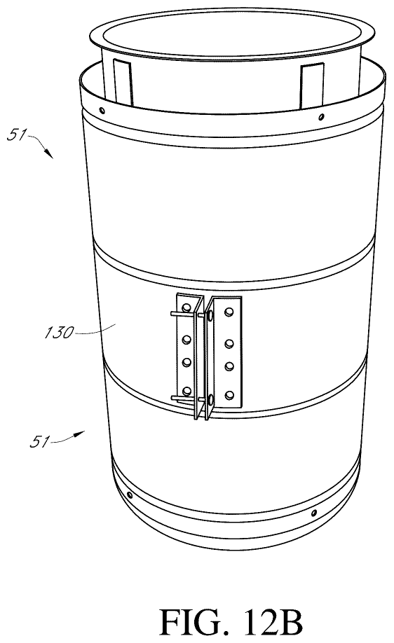

Referring now to FIG. 12A, which provides a detailed perspective view of various aspects of a joint seal system & method, it is contemplated that in one application, all or a portion of the flanges 24, 34 at a flange interface 36 of two sections 20, 30 may be positioned within the angled portion 117, and the flat portions 118 may extend around a portion of the exterior surface of either section 20, 30 adjacent the flanges 24, 34, and the seal 120, flanges 24, 34, and band 110 may cooperate to form a hermetic or nearly hermetic seal capable of preventing pressure leakage, flue gas leakage, and/or condensate leakage at pressure differentials up to 1.5 ATMs from ambient pressure (either positive or negative) as described in further detail below.

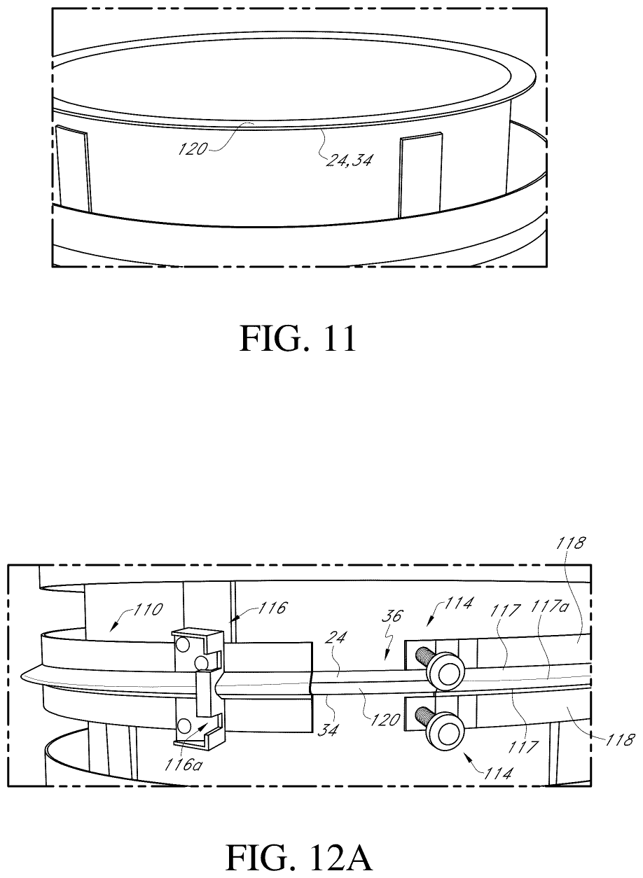

In an aspect, a seal 120 may be positioned at the flange interface 36 of two sections 20, 30. Still referring to FIG. 12A, two adjacent flanges 24, 34 may have at least one seal 120 positioned therebetween at a flange interface 36. The seal 120 may abut each flange 24, 34 of the two adjacent sections 20, 30. As depicted in FIG. 12A, the band 110 is not yet tightened around the flange interface 36, and the connector(s) 114 are not yet engaged with the anchor 116, the process of which is described in further detail below. Such a configuration may dispense with the need to use a sealant between the flanges 24, 34, and/or allow for a hermetic seal between the flanges 24, 34, thereby mitigating and/or eliminating the pressure, flue gas, and/or condensate leakage at the flange interface 36, deficiencies in which are common to designs found in the prior art. In an aspect, the seal 120 may be between 1/32 and 5/32 of an inch thick, and the difference between the outer diameter and inner diameter may be between 0.5 and 1.5 inches without limitation unless so indicated in the following claims. It has been found that Aero Rubber Company and Sur-Seal manufacture seals 120 that may be suitable for certain applications. A seal 120 positioned on a single flange 24, 34 is shown in perspective in FIG. 11.

It is to be understood that the connector 114 and/or anchor 116 may be configured such that the tension of the band 110 (and in some aspects, consequently the amount by which the seal 120 is compressed) may be adjustable, such that as the band 110 is tightened, the force the band 110 exerts on the abutting flanges 24, 34 increases in at least one dimension, and in two dimensions for certain configurations, wherein a first dimension generally may be normal to the flanges 24, 34 and a second dimension generally may be parallel to the flanges 24, 34. It is contemplated that in some applications, as a force in the first dimension increases, the two flanges 24, 34 may be urged toward one another, which may reduce the propensity for pressure, flue gas, and/or condensate to pass through a flange interface 36.

Referring again to FIG. 12A, in one aspect a band 110 may be configured with two connectors 114, wherein each connector 114 may be positioned on either flat portion 118 to engage a corresponding portion of the anchor 116. In an aspect, each connector 114 may be configured as a barrel bolt, wherein one end thereof may be pivotally engaged with a respective flat portion of the band 110. The barrel bolt may be pivoted toward the anchor 116 such that a threaded portion of the barrel bolt is positioned within a slot 116a formed in the anchor 116, and a nut (which may be positioned on the side of the slot 116a in the anchor 116 opposite the connector 114) may be tightened along the barrel bolt, thereby reducing the distance between the connector 114 and the anchor 116. However, other configurations of anchors 116 and/or connectors 114 may be employed with the joint seal system & method without limitation unless so indicated in the following claims.

It is further contemplated that certain seals 120 may have an optimal amount of deformation to achieve the best seal between two flanges 24, 34, which optimal amount of deformation may depend at least upon the material used to construct the seal 120. The seal 120 may be constructed of any suitable material for the particular application thereof, including but not limited to synthetic materials, cellulosic materials, natural materials, and/or combinations thereof without limitation unless so indicated in the following claims. Furthermore, in certain applications, a seal 120 may be employed in conjunction with another sealant material, such as a liquid, paste, epoxy, and/or other sealant material.

In an aspect, the joint seal system & method may be used with an insulated chimney system 50.

In such a configuration, a separate exterior band 130 may be positioned around the flange interface 36 and the entire band 110, one example of which is shown in FIG. 12B. Without limitation unless so indicated in the following claims, additional insulative material may be positioned between the external surface of the joint seal system & method (e.g., the area adjacent the band 110 in FIG. 12A) and the interior surface of the exterior band 130 to achieve higher thermal efficiency, better mitigation of leaks, or for any other reason suitable for the specific application.

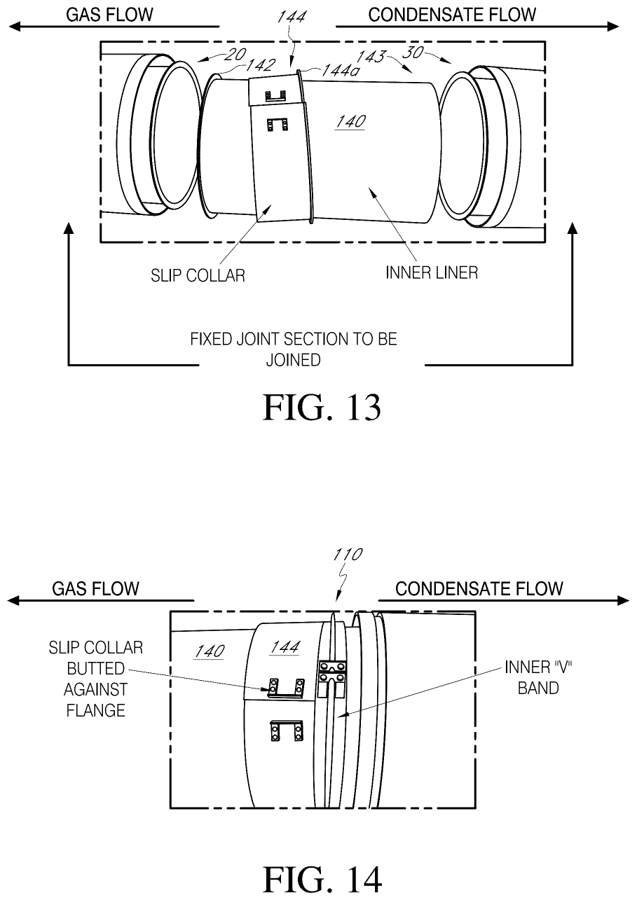

Referring now to FIGS. 13 & 14, the joint seal system & method may be configured to adapt for variable distances between two fixed sections 20, 30. As shown in FIG. 13, an intermediate section 140 may have a slip collar 144 positioned over a portion of the intermediate section 140. The slip collar 144 may be moveable along a length of the intermediate section 140, and one end of the intermediate section 144 may be formed with a fixed flange 142 opposite a free end 143 of the intermediate section 140. The slip collar 144 may be configured with a slip collar flange 144a of similar utility and/or dimensions to other flanges 24, 34 described and disclosed herein.

Generally, it is contemplated that the fixed flange 142 may be engaged with a flange 24, 34 of a section 20, 30 that is downstream (with respect to an appliance) and that the slip collar flange 144a may be engaged with a flange 24, 34 positioned on a fluid conduit that is engaged with an appliance. Accordingly, gas and/or vapor flow may proceed in a first direction and condensate may flow in an opposite direction, as shown in FIGS. 13 & 14. The intermediate section 140 May accommodate various lengths between to fixed sections 20, 30 by allowing adjustability of the distance by which the free end 143 is inserted one of the fixed sections 20, 30.

As depicted in FIG. 14, after the free end 143 is inserted into a first fixed section 20 by the desired amount, the fixed flange 142 of the intermediate section 140 may be engaged with the second section flange 34, and a band 110 may be secured over that flange interface 36 to secure the relative positions of the second section 30 and intermediate section 140. Next, the slip collar may be moved along the length of the intermediate section 140 toward the first section 20 until the slip collar flange 144a abuts the first section flange 24. A band 110 may then be positioned over the flange interface 36 of the slip collar flange 144a and the first section flange 24 to secure the relative positions of the slip collar 144 and the first section 20.

The slip collar 144 may be formed with an anchor and connector, which anchor and connector may be configured in a manner similar to that previously described for the band 110. Generally, the anchor and connector for the slip collar 144 may serve to selectively secure the position of the slip collar 144 with respect to the intermediate section 140. Accordingly, any suitable structure and/or method may be used to selectively secure the position of the slip collar 144 at specific position on the intermediate section without limitation unless so indicated in the following claims.

### Further Embodiments of a Joint Assembly (High Heat)

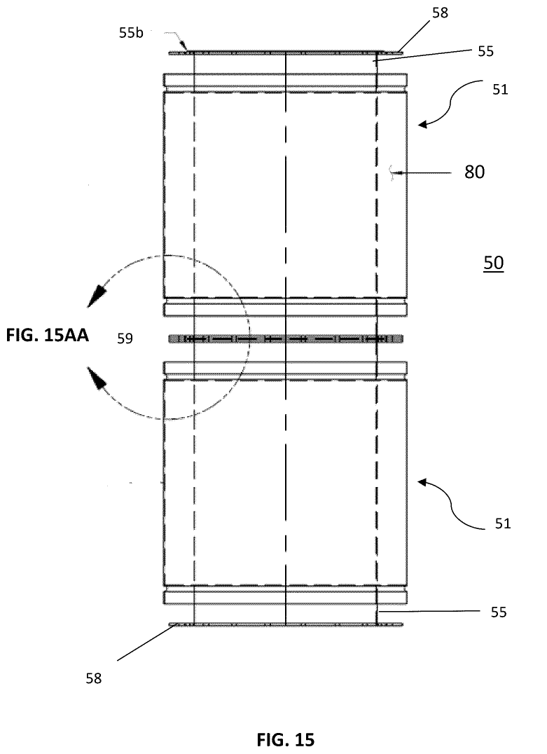

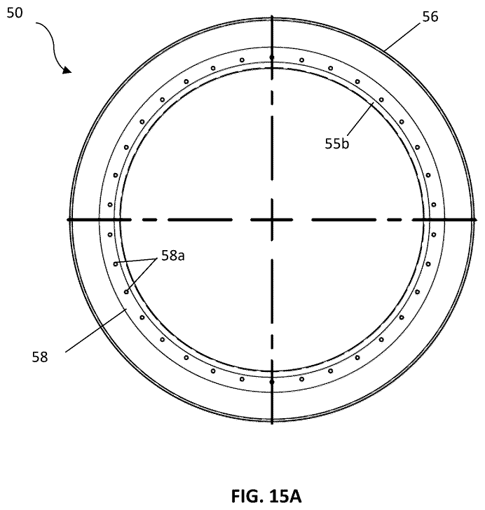

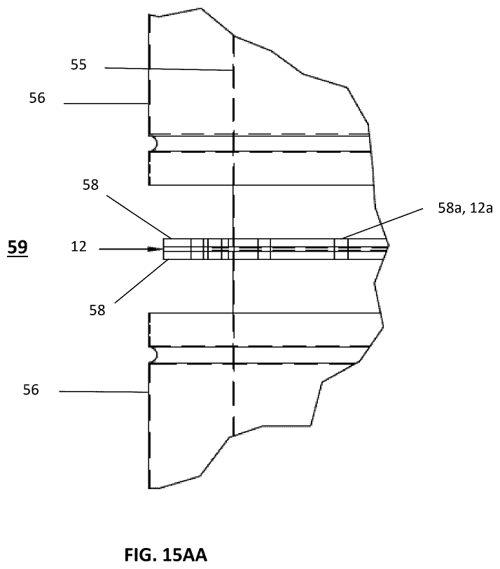

Another chimney section 51 and joint seal system and method for two adjacent chimney sections 51 configured according to the present disclosure is shown in FIGS. 15A & 15B. Generally, this joint seal system and method may be configured to provide a high-performing leak-free joint seal 59 (e.g., very minimal to no detectable fluid leaks) in a high-temperature application, such as an engine generator exhaust system, wherein the joint assembly may be used in joints on a chimney system for venting engine generator exhaust. In such an application the joint seal system and method may be configured to perform suitably in temperatures as low as −50° F. to temperatures as high as 1200° F. without limitation unless so indicated in the following claims. Currently, the only design that achieves such a level of performance is welded joints or UL-listed, prefabricated joints. However, for both of those prior art solutions leakage is allowed, making the joint seal system and method described and disclosed herein superior.

The chimney section 51 shown in FIGS. 15A & 15B may be configured as a single wall or double-wall prefabricated section with between 2 and 6 inches of insulation between the inner diameter and the outer diameter. However, other amounts of insulation may be used without limitation unless so indicated in the following claims, and the optimal amount of insulation May vary from one application to the next. For example, it has been found that for one application, 4 inches of insulation may be optimal, while for a second application 5 inches of insulation may be optimal. For still another application, six inches of insulation may be optimal. Each chimney section 51 may be configured with an inner flange 55a that may be configured as a ½-inch roll lip defined as an inner shell rim 55b and inner shell spinner bolt flange 58, but which may be differently configured in other embodiments without limitation unless so indicated in the following claims. At least the inner shell spinner bolt flange 58 may be produced using 7-gauge metallic material (such as aluminum, steel, stainless steel, etc.), but the scope of the present disclosure is not so limited and other materials, thicknesses, etc. may be used unless otherwise indicated in the following claims.

Multiple chimney sections 51 may be engaged with adjacent chimney sections 51 to form a modular, prefabricated system that may be configured to have relatively high heat resistance and simultaneously high positive or negative pressures (e.g., in applications ranging from 0.5 psi to 4 psi positive or negative gauge pressures without limitation unless so indicated in the following claims) sealing/leak mitigation capabilities. In one aspect such a system may be used as a vent for generator exhaust. However, other applications of the system exist without limitation unless so indicated in the following claims. The modular system may be comprised of one or more chimney sections 51 configured in sizes and shapes that are relatively lightweight and easy-to-handle lengths. For example, it is contemplated that for some applications it may be advantageous to configure a chimney section 51 with a length of between 8 inches and 70 inches, an inner diameter of between 4 inches and 54 inches, and having a weight of between 20 to 350 pounds. However, the specific physical dimensions, shape, weight, etc. of each chimney section 51 in no way limits the scope of the present disclosure unless so indicated in the following claims.

The joint seal system and method may be configured for use between two adjacent chimney sections 51 and may be further configured with a high temperature and pressure-tight gasket 12 between adjacent inner flanges 55a of two separate chimney sections, and a plurality of mechanical fasteners may be used to engage two adjacent inner flanges 55a via inner shell spinner bolt flanges 58. The gasket 12, having gasket apertures 12a, may be comprised of graphite but is not so limited unless indicated in the following claims. Additionally, in one embodiment adjacent inner flanges 55a of two chimney sections 51 may each have a high-temperature gasket 12 pre-installed on the associated inner flange 55a, such that the abutting inner flanges 55a form a gasket-to-gasket seal utilizing two gaskets 12 immediately adjacent one another. It is contemplated that such a gasket-to-gasket seal (as opposed to a traditional seal utilizing only one gasket 12 positioned between two opposing flanges) may mitigate and/or eliminate the likelihood of fluid leaks between the two chimney sections 51. The optimal materials of construction for the gasket 12 may vary from one application of the joint seal system and method to the next, and is therefore in no way limiting to the scope of the of the present disclosure unless otherwise indicated in the following claims. Such materials of construction may include, but are not limited to, rubber materials (e.g., silicon, fluorosilicone, vulcanized rubber, ethylene propylene diene monomer rubber, etc.), carbon-based materials (carbon, fluorocarbon, polytretrafluoroethylene), ceramic fiber materials, and/or combinations thereof.

Any suitable mechanical fastener may be used to engage one chimney section 51 with another, via the inner shell spinner bolt flange 58 with apertures 58a such as bolts with corresponding nuts, screws, rivets, clamps, and/or combinations thereof without limitation unless so indicated in the following claims. Additionally, the number and size of mechanical fasteners may vary from one application to the next, and in one embodiment the mechanical fasteners may be configured as ¼-inch bolts having a length between 1 and 4 inches and corresponding nuts. Accordingly, the specific apparatus and/or method used to secure adjacent chimney sections 51 to one another in no way limits the scope of the present disclosure unless so indicated in the following claims.

Furthermore, a chimney section 51 may be configured as a straight section, expansion joint, tee, elbow, angled member, support devices, etc. without limitation unless so indicated in the following claims, such that a prefabricated system may be configured as a complete exhaust system to be assembled from standard components.

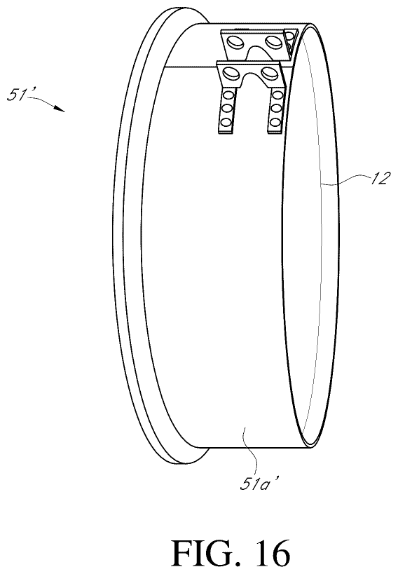

In another embodiment of a joint seal system & method, a starter section 51′, as shown in FIG. 16, may be configured for installation with a raw appliance outlet (not shown). In such an application, a starter section 51′ may be formed with a starter section collar 51a′. A gasket 12 may be engaged on an interior surface of the starter section collar 51a′ in a manner such as that previously described for the inner flange 55a of a chimney section 51 without limitation unless otherwise indicated in the following claims. The starter section collar 51a′ may be positioned on the appliance outlet such that the gasket 12 engages an exterior surface of the appliance outlet. The starter section 51′ may be secured to the appliance outlet in any manner as previously described for securing the position of the slip collar 144 as previously described herein without limitation unless otherwise indicated in the following claims. In this way, a starter section 51′ may facilitate a leak-free (or nearly leak-free) connection for an appliance outlet to another chimney section 51 utilizing the joint seal system & method, and thereby may provide a high-performing seal (e.g., very minimal to no detectable fluid leaks) in a high-temperature application directly from an appliance outlet.

### Another Embodiment of a Joint Assembly (Low Temperature)

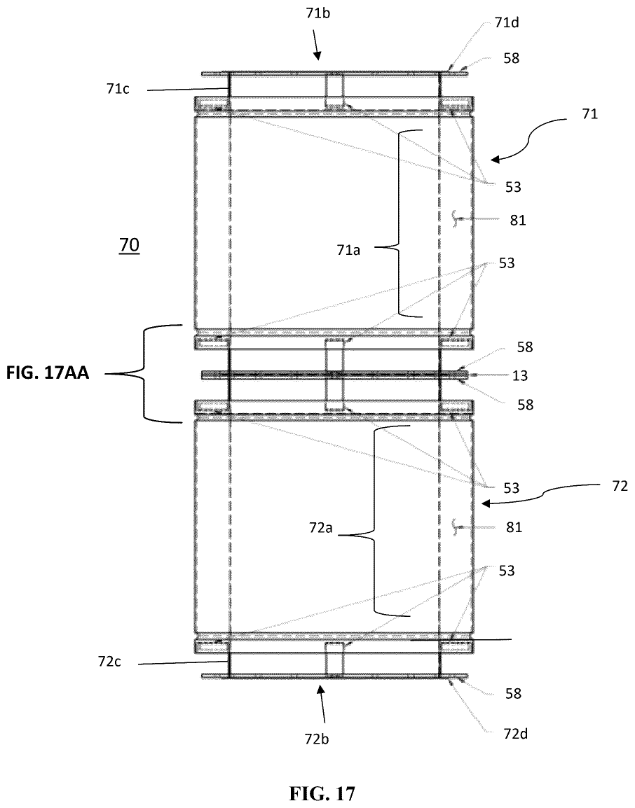

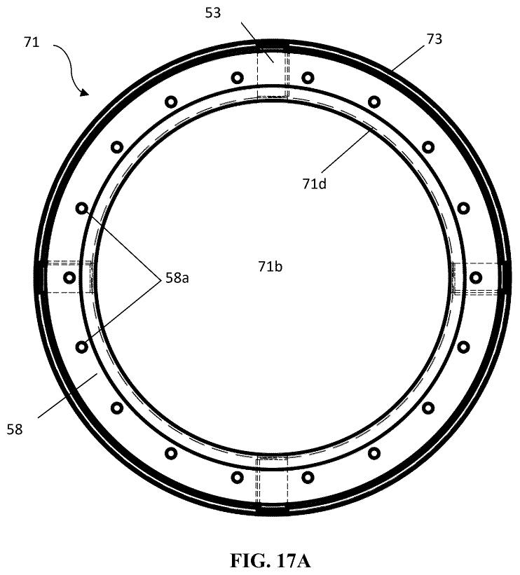

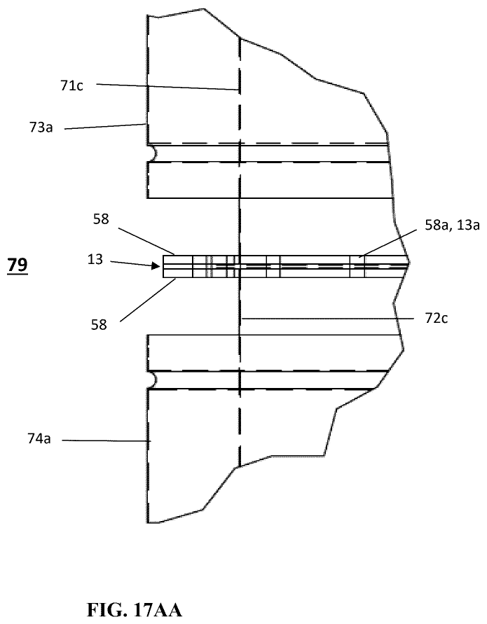

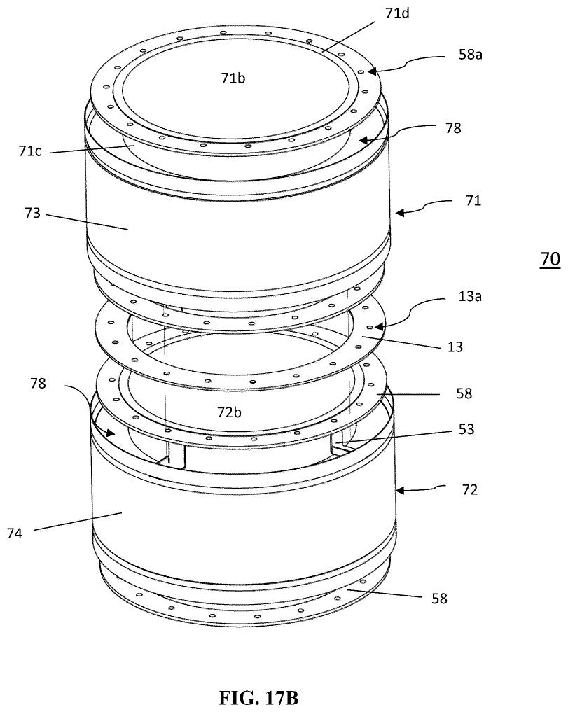

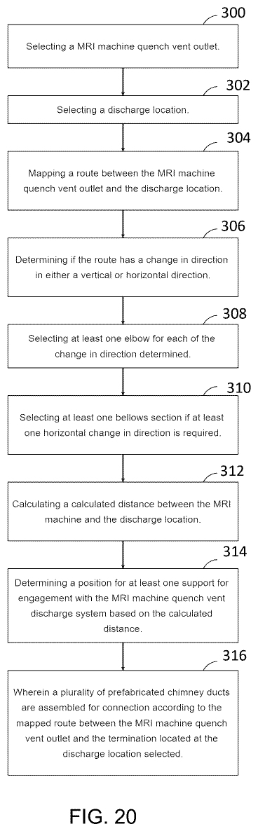

Another embodiment of the chimney system 70 and joint seal system and method having two adjacent chimney sections (71, 72) configured according to the present disclosure is shown in detail in FIGS. 17-19. As disclosed and configured, this embodiment of the chimney and joint seal assembly is suitable for use with the demands of an MRI machine quench system (aka “helium quench pipe” or “MRI quench pipe”) which must be configured to provide a vent out and away of the liquid helium from the MRI machine (and patients and medical professionals) safely to the outside atmosphere as illustrated in FIGS. 20-26. Therefore, to understand this particular application, a general understanding of MRI technology and systems, which are well known to one of ordinary skill, is necessary.

Magnetic Resonance Imaging (MRI) systems use magnets and radio waves to create detailed images of the inside of the body. The MRI machine produces a strong magnetic field that causes hydrogen atoms in the body to align. When a radiofrequency current is sent through the body, the atoms spin out of equilibrium, and the MRI sensors detect the energy released when the field is turned off. The computer then uses these signals to create digital images of the scanned area. Generally, MRI systems are well suited to imaging soft tissues and non-bony parts of the body, such as muscles and organs. MRI systems can produce cross-sectional images, like slices of bread, and 3D images that can be viewed from different angles. MRI machines are typically large and tube-shaped. The magnets are cooled to −269° C. (negative 452.2 degrees Fahrenheit) using liquid helium in a cryostat system, which achieves superconductivity. The material that makes these magnets so powerful is liquid helium, which takes the resistance in the coil windings around the magnet down to zero. This allows the electrical current to flow continuously as long as the liquid helium is maintained at a steady negative 452.2 degrees Fahrenheit (−452.2 Deg. F). During “normal” operation of the MRI machine, the electromagnets of the MRI machine require an exhaust system for its cooling system. Normal operating temperatures and pressures in the exhaust system are 1-4 PSIG and 70-150 degree F. MRI systems may also experience a condition called a “MRI Quench” which occurs when there is a rise in the electromagnet's temperature resulting in a loss of superconductivity, i.e. the resistance in the electrical current is no longer zero. This causes a chain reaction: ever-increasing resistance causes more and more heat, which causes the liquid helium to boil into gas, which causes pressure to build until there is a sudden, dramatic, and potentially expensive, release of helium gas. An emergency quench (where the MRI quenches on its own), can be caused by a leak, ice in the magnet, a failure in the magnet's cooling system, or even critically low helium levels. An emergency quench may also be triggered by the introduction of metal into the MRI which requires an immediate shutdown, particularly, if a patient is endangered. In this situation, medical personnel push an “emergency” button which heats the magnet, starting the chain reaction described above resulting in a “quench event”. A planned quench is sometimes used by an engineer when an older and no longer usable magnet is being decommissioned.

Generally, this joint seal system and method may be configured to provide a high-performing seal (e.g., very minimal to no detectable fluid leaks) in an extremely low temperature application, such as an MRI quench exhaust system, wherein the joint assembly may be used in joints on a chimney system capable of withstanding drastic shifts in temperature from ambient to that of liquid helium within seconds during a quench event. A failure of the MRI quench system could result in helium leaking into the room and jeopardizing patient safety.

In such an application the joint seal system and method may be configured to perform suitably in temperatures as low as −452.4° F. to temperatures as high as 130° F. and pressures as high as 17 PSIG without limitation unless so indicated in the following claims. Currently, the only design that achieves such a level of performance is welded joints or UL-listed, prefabricated joints.

However, for both of those prior art solutions leakage is allowed, making the joint seal system and method described and disclosed herein superior.

FIG. 17 provides a side view of two chimney sections engaged with one another which may form a chimney system 70. The chimney system 70 of FIG. 17 is comprised of adjacent connected chimney sections (71, 72) and may be configured either as a single wall or as a double-wall prefabricated section with between 2 and 6 inches of insulation between the inner diameter (71,72) and the outer diameter (73,74). However, other amounts of insulation may be used without limitation unless so indicated in the following claims, and the optimal amount of insulation may vary from one application to the next. For example, it has been found that for one application, four (4) inches of insulation may be optimal, while for a second application five (5) inches of insulation may be optimal. For still another application, six (6) inches of insulation may be optimal.

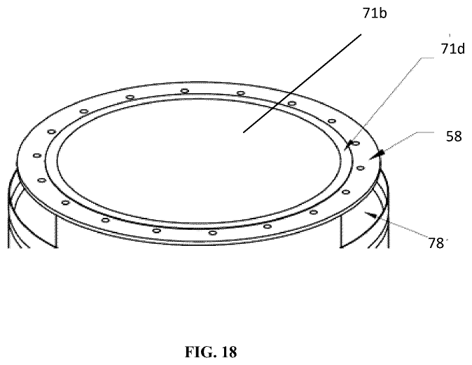

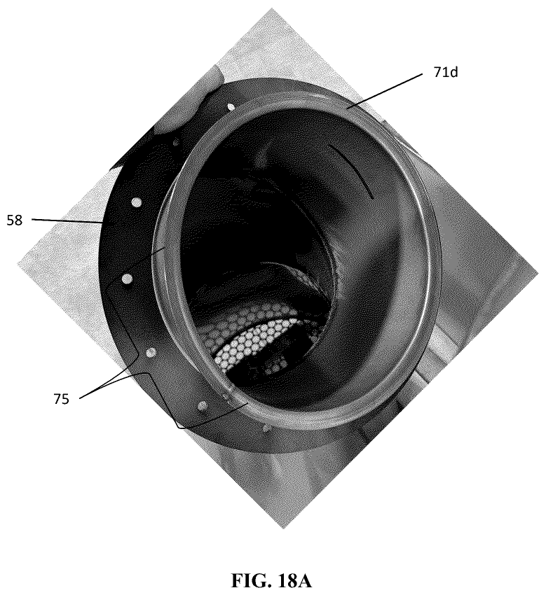

As shown, the insulated chimney duct system 70 may be configured with a first insulated chimney section 71 and a second insulated chimney section 72 connected to form another embodiment of the joint seal 59 which is leak-free. (See FIGS. 17, 17AA and 17B) An insulated chimney first section 71 may be configured with a first section inner shell body 71a having a first section inner shell body interior 71b and first section inner shell body exterior 71c having a first section inner shell rim 71d at each end of the first section 71 therein. Similarly, insulated chimney second section 72 is configured with a second section inner shell body 72a, second section inner shell body interior 72b and second section inner shell body exterior 72c having a second section inner shell rim 72d at each end of the second section 72 therein. As shown in FIGS. 17A and 17B, similar to FIGS. 15-15A, the inner shell rim (71d, 72d) is formed as a half-inch (0.5″) rolled lip. An inner shell spinner bolt flange 58 is configured as a collar to surround the inner shell body exterior 71c and is positioned at each end of each section. FIG. 18A illustrates the inner shell spinner bolt flange 58 partially disassembled (loose) from inner shell rolled lip 71d further illustrating the inner shell spinner flange/inner shell rim interface 75. The inner shell spinner bolt flange 58 is configured with apertures 58a around its perimeter and engages with the inner shell rim (71d, 72d) to form an inner shell spinner bolt flange/inner shell rim interface 75 as illustrated at FIG. 18. The chimney sections (71, 72) are then connected via the assembled joint 79 by positioning a low temperature gasket 13, also having apertures 13a positioned therein, between the adjacent inner shell spinner bolt flanges 58 for each insulated chimney section (71, 72).

Generally, the chimney sections (71,72) configured for use with a modular system may be configured with the inner shell spinner bolt flanges 58 that are rotatable with respect to the chimney sections (71,72) such that apertures 58a formed therein may be aligned with apertures 58a in the corresponding the inner shell spinner bolt flange 58 of an adjacent chimney section (71,72). The low temperature gasket 13 may be comprised of polytretrafluoroethylene (PTFE) for cold temperatures but is not so limited unless indicated in the following claims. In at least one embodiment as disclosed herein, a low temperature gasket having properties as listed in Table 1herein was found to be suitable for an MRI machine quench vent system 200.

| | |
|---|---|
| Service Temperature | −450 to 500° F. |
| Service Pressure | 0 to 3000 psi |
| Compressibilty (after 1 hour at 210° F.) - | 65% |
| ASTM F36A | |
| Recovery ASTM F36A | 12% |
| Creep Relaxation ASTM F38B at 212 F. | 32% |
| Sealability ASTM F37A | 0.001 ml/hr |
| Scalability Din 3535 | less than 0.016 cm3/min |
| FDA Approval | 21 CFR 177.2600 |

### Table 1: Performance and Physical Properties for Low Temperature Gasket 2

Although not shown, it will be understood from at least FIG. 17AA, and the written disclosure herein, that alignment of each inner shell spinner bolt flange 58 so that its apertures 58a align with the gasket apertures 13a for insertion of fasteners, such as ¼ inch bolts with securing nuts (180), without limitation or restriction, facilitates formation of a leak-proof seal via assembled joint 79 between the chimney sections (71, 72) capable of withstanding the operating pressures and temperatures disclosed herein.

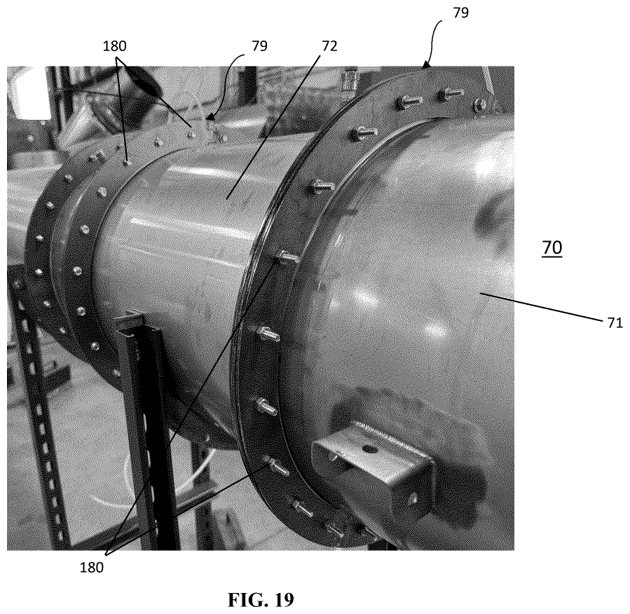

In FIGS. 17-18, the chimney system 70 is double walled with outer shell (73,74) positioned around the inner shell (71, 72). The first section outer shell 73 having outer shell exterior 73a may be positioned around the inner shell first section 71. The second section outer shell 74 with second section outer shell exterior 74a may be positioned around the inner shell second section 72. As the outside diameter of the assembled joint 79 is greater than the inner shell exterior (71c, 72c) but less than the outer shell interior (73, 74) an insulation gap 78 is created. Although not shown but understood, insulation 80 may be positioned in the insulation gap 78. FIG. 19 illustrates a single wall chimney system 70 assembled from three (3) chimney sections (71, 72) prior to installation of insulation 80. As shown, the chimney sections (71,72) are connected to form another embodiment of the joint seal 79 deploying inner shell spinner bolt flanges 58 at each end of the inner shells (71a,72a).

Assembly and connection of adjacent chimney sections (71, 72) may be used to form a modular, prefabricated chimney system 70. In one aspect such a system may be configured for rapid change in temperature from ambient to very cold to handle an MRI quench event with relatively high cold temperature resistance and simultaneously high positive or negative pressures (e.g., in applications ranging from 0.5 psi to 4 psi positive or negative gauge pressures without limitation unless so indicated in the following claims) sealing/leak mitigation capabilities. However, other applications of the system exist without limitation unless so indicated in the following claims.

The modular prefabricated chimney system 70 may be comprised of one or more chimney sections (71,72) configured in sizes and shapes that are relatively lightweight and easy-to-handle lengths. For example, it is contemplated that for some applications it may be advantageous to configure a chimney section (71,72) with a length of between 8 inches and 70 inches, an inner diameter of between 4 inches and 54 inches, and having a weight of between 20 to 350 pounds.

However, the specific physical dimensions, shape, weight, etc. of each chimney section 71 in no way limits the scope of the present disclosure unless so indicated in the following claims. The chimney system 70 comprised of adjacent connected chimney sections 71 shown throughout the figures configured as a single wall prefabricated section is also shown at FIG. 19.

Having described an illustrative embodiment of a chimney system 70 and joint seal system and method for use in extremely low temperature, positive pressure applications, a method of assembling such a leak-free joint seal 79 will now be described in detail. The following method is for illustrative purposes only and in no way limits the scope of the present disclosure unless so indicated in the following claims.

After the adjacent inner shell spinner bolt flanges 58 are properly aligned (i.e., the inner shell spinner bolt flange apertures 58a are also aligned) a low temperature gasket 13 may be positioned therebetween. A final alignment of the apertures 58a in the adjacent spinner flanges and the gasket apertures 13a may then be performed, and mechanical fasteners 180 (bolts and corresponding nuts in the illustrative embodiment) may be positioned in the apertures 58a. The mechanical fasteners may be intermittently tightened around the adjoining spinner bolt flanges 58 to approximately 5-8 foot-pounds of torque thus forming the joint seal 79 for low temperature and leak-free operation. However, in other applications the optimal torque of a mechanical fastener may be greater or lesser than that amount without limitation unless so indicated in the following claims. In still other applications, chemical adhesives may be used in place of or in addition to mechanical fasteners without limitation unless so indicated in the following claims.

After all mechanical fasteners have been adequately tightened to ensure a leak-free seal, an insulation strip may be positioned over the joint seal 79 (i.e., the area adjacent the two corresponding spinner bolt flanges 58). An outer (exterior) band 130, which may be formed as a flat material with a periphery of similar or identical size and shape of that of the chimney section 71, may be positioned over the insulation strip 81 and engage a portion of the outer shell (73, 74) of each adjacent chimney section 71 and may be secured thereto with any suitable method or apparatus including but not limited to mechanical fasteners (bolts, screws, rivets, etc.), chemical adhesives, and/or combinations thereof. It is contemplated that for certain applications (e.g., outdoor applications) it may be advantageous to apply a chemical sealant (e.g., S600 sealant) to all or a portion of each edge of outer band 30.

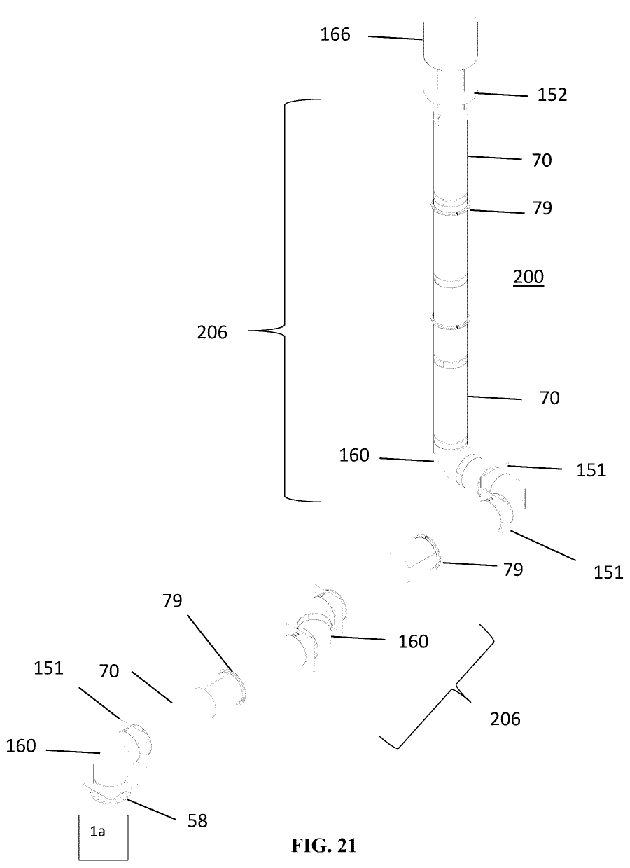

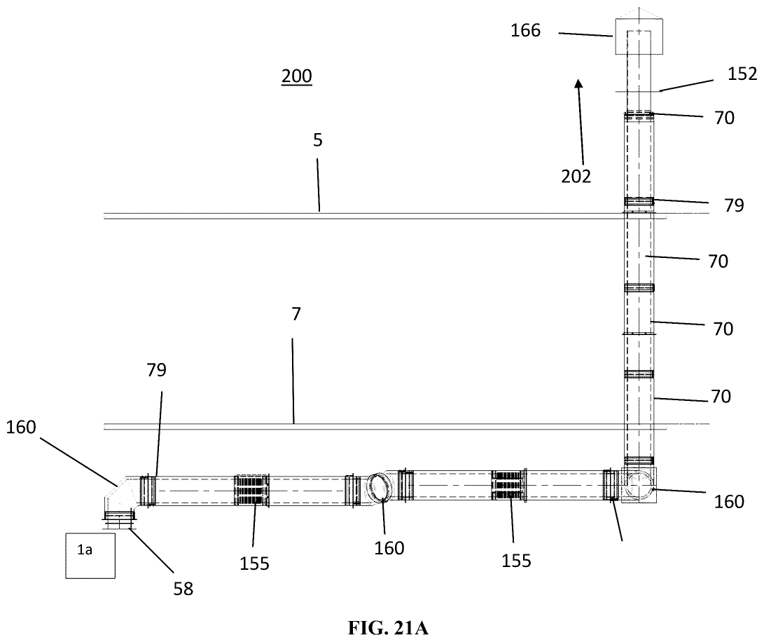

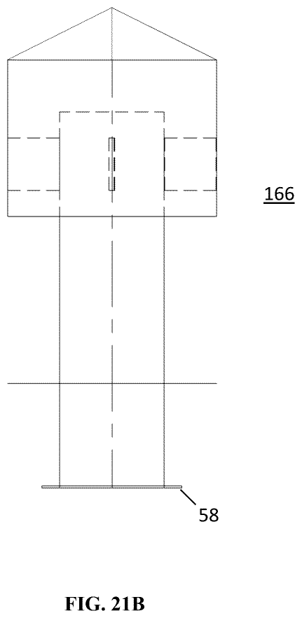

One of ordinary skill will appreciate that any suitable mechanical fastener 180 may be used to engage one chimney section 71 with another, such as bolts with corresponding nuts, screws, rivets, clamps, and/or combinations thereof without limitation unless so indicated in the following claims. Additionally, the number and size of mechanical fasteners may vary from one application to the next, and in one embodiment the mechanical fasteners may be configured as 12¼-inch bolts having a length between 1 and 4 inches and corresponding nuts. Accordingly, the specific apparatus and/or method used to secure adjacent chimney sections 71 to one another in no way limits the scope of the present disclosure unless so indicated in the following claims. Furthermore, a chimney section 71 may be configured as a straight section, expansion joint, bellows sections 155, tees (not shown but understood), elbows 160, or other angled member, with support 150 devices including support plates 151, hangers 152 and rings 153 without limitation unless so indicated in the following claims, such that a prefabricated system may be configured as a complete exhaust system to be assembled from standard components as illustrated by all of the figures herein and particularly FIGS. 21-25.

The disclosure provides a method for creating a weld-free MRI machine quench vent discharge system using pre-fabricated chimney duct components. The system may include selecting an MRI machine quench vent outlet 1a and a discharge location 202 to determine where the quench gas will be vented. A route can be mapped to connect the MRI machine quench vent outlet to the discharge location, which may involve generating sections in both horizontal and vertical planes.

Components such as elbows and bellows sections may be selected to accommodate changes in direction and handle thermal contraction. The distance between the MRI machine and the discharge location 202 can be calculated to position supports like hangers, plates, and full rings to support the chimney duct. The system may be assembled by connecting prefabricated chimney duct sections to create a secure, leak-free connection using spinner bolt flanges and PTFE cryogenic cold gaskets. The method can ensure a reliable and insulated chimney system for safe venting of quench gases.

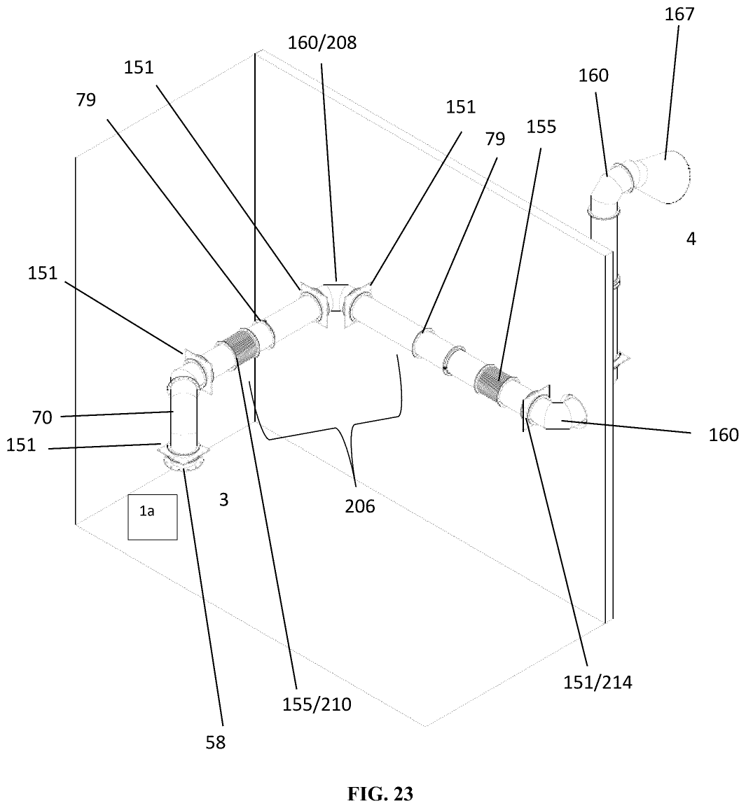

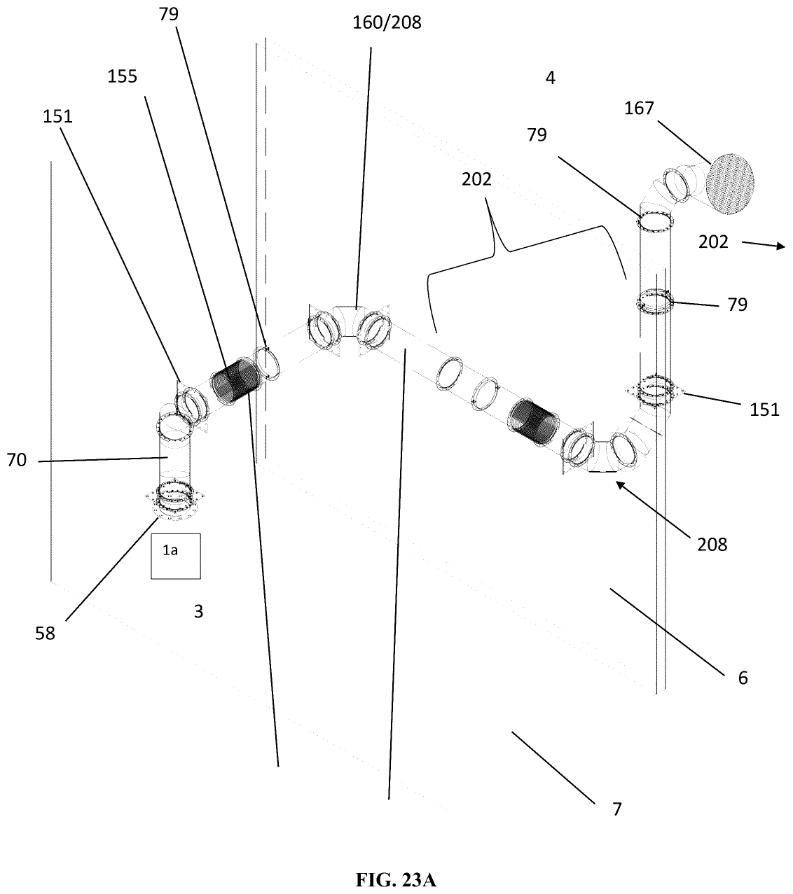

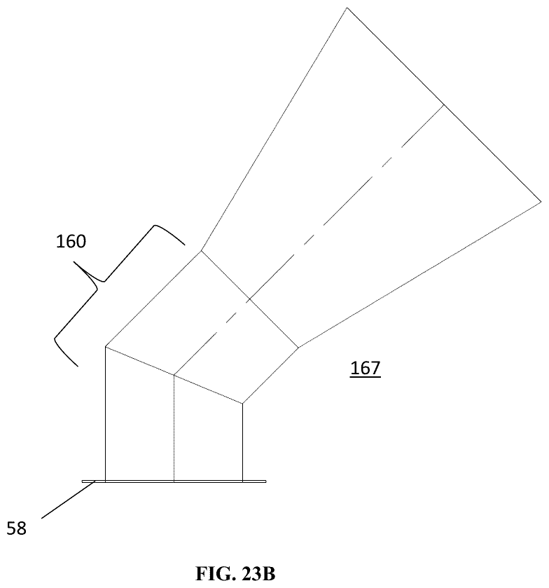

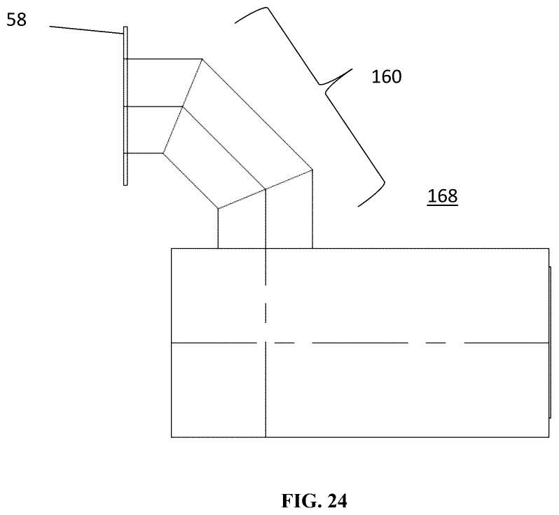

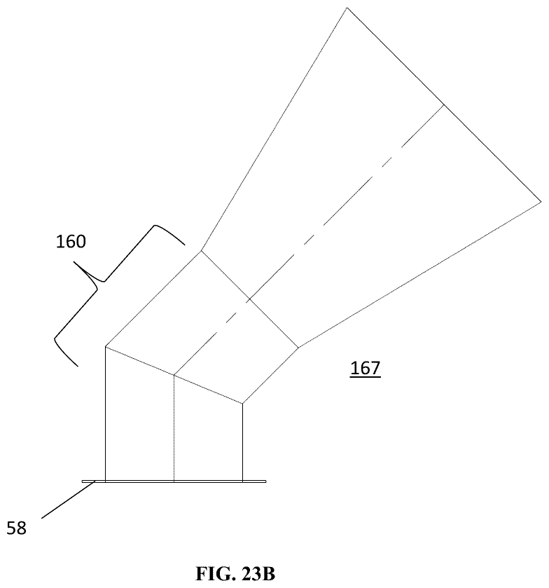

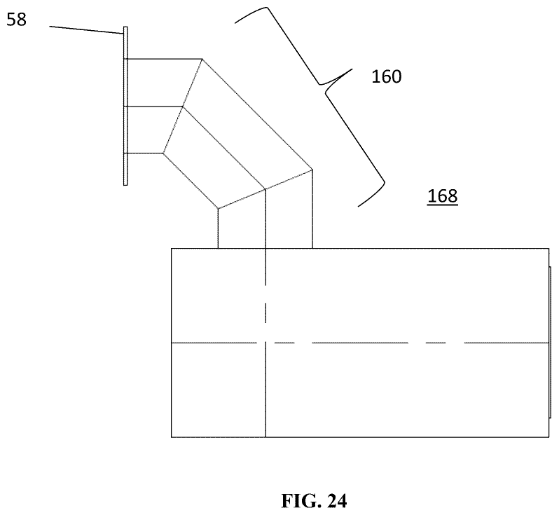

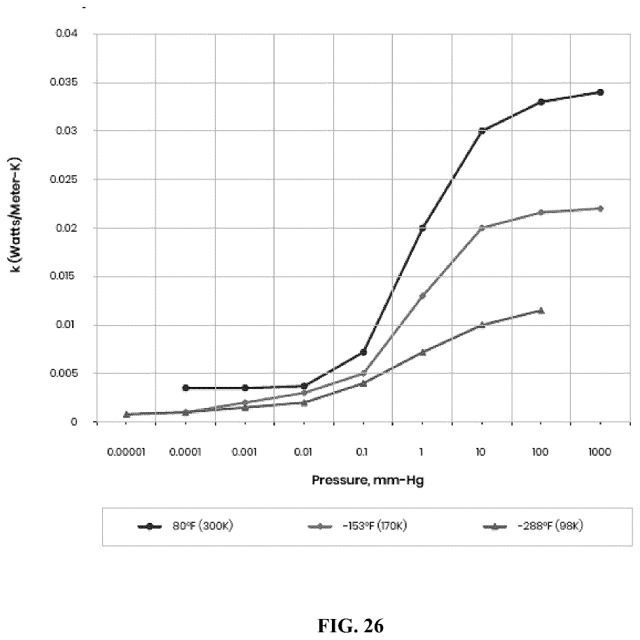

A method of configuring and assembling a weld-free MRI machine quench vent system 200 from pre-fabricated chimney duct 70 components for an MRI machine quench vent discharge is disclosed. The method of assembling the weld-free MRI machine quench vent system 200 comprises selecting an MRI machine quench vent outlet 1a. As shown at FIG. 26 the quench vent outlet 1a is typically located on the exterior of the MRI machine extending vertically from the top of the MRI machine 1. The MRI machine 1 is typically located in a protected and secured interior structure, such as a hospital treatment center. A discharge location 202 for venting the quench gas is then selected. As understood by those knowledgeable in this field, the discharge location 202 is typically an area exterior of the interior structure. However, in some applications, the discharge location 202 may also be located in an interior area, particularly if the termination 165 selected is a discharge box for use as a diffuser. As the helium gas vented from the MRI machine 1 during a quench event undergoes rapid expansion and is (or approaches) −452.4 degrees Fahrenheit, the discharge location 202 must allow for safe discharge to protect people and property. As previously discussed, and illustrated at least by FIGS. 21-25, after the discharge location 202 is selected, a route 204 for connecting the MRI machine quench vent outlet 1a to the discharge location 202 is generated. One of ordinary skill will appreciate that the generated route may have sections or components generally in the horizontal plane, sections or components generally in the vertical plane and sections or components which transition from one plane to the other. The termination 165 for the MRI machine quench vent system 200 is selected based on the selected discharge location 202 and the generated chimney duct route 204. A termination 165 for use with a roof-top (generally in the horizontal plane) which is shown at FIGS. 21 and 21A is known as a capped roof termination 166. FIG. 24 provides a detailed view of a capped roof termination 166. As illustrated at FIGS. 21 and 21A, the chimney duct connected to the capped roof termination 166 is generally orientated in the vertical plane to extend vertically up and through the roof-top of the interior space. A termination 165 for use with a chimney duct system 70 generally in the horizontal plane and extending into and through a vertical wall is illustrated at FIGS. 23 and 23A. In at least one embodiment, the terminations 165 are configured with at least one end adapted for connection with another section of prefabricated chimney duct for an insulated chimney system 70 with an inner shell spinner bolt flange/inner shell rim interface as illustrated in FIGS. 17-19.

In at least one illustrative embodiment, the distance between the MRI machine and the discharge location is calculated to further determine where supports 150 for the chimney duct 70 for the vent system 200 are to be positioned. For purposes of illustration only, a support 150 may be positioned every twelve (12) feet as suitable for a particular application. Positioning supports 150 more or less frequently may be suitable for other conditions without departure from the scope of the present disclosure. A suitable support 150 may be selected from plates 151, hangers 152 and full rings 153, as shown in FIGS. 21-23A, or combinations therein. The supports 150 may be affixed to the chimney duct sections 70 by welding or any other methods of securement suitable for a particular application for proper support and reliability, without limitation or restriction.

The generated route should be further analyzed to determine if the generated route has a change in direction in the horizontal plane. See called-out sections FIG. 21A and FIG. 23A. An elbow section 160 is necessary for each change in direction and illustrative elbow sections 160, without limitation or restriction, may include thirty (30), forty-five (45) and ninety (90) degree bends. In at least one embodiment, the elbow sections 160 are configured as prefabricated chimney ducts for an insulated chimney system 70 with an inner shell spinner bolt flange/inner shell rim interface as illustrated in FIGS. 17-19.

Each change in direction in the horizontal plane may require installation of at least one bellows section 155. In at least one embodiment, a bellows section 155 may also be required by the length of a particular section of the chimney duct 70. For purposes of illustration only, a bellows section 155 is positioned every thirty (30) feet. Positioning a bellows section 155 between chimney duct sections 70 more or less frequently may be suitable for other conditions without departure from the scope of the present disclosure. In at least one embodiment, the bellows section 155 is used to compensate for thermal contraction in the quench vent system 200 composed of prefabricated chimney duct sections 70 which are subject to high-pressure, low temperature applications. In at least one embodiment, not shown but understood, a termination 165 may be positioned directly above (in the vertical plane) the MRI machine quench vent outlet 1a. In this particular embodiment, no bellows section 155 would be required. A quench vent system 200 is assembled by then connecting a plurality of prefabricated chimney duct sections 70 to fluidly connect the MRI machine vent outlet 1a to the termination 165 according to the generated route 202. In at least one embodiment, the prefabricated duct sections 70 may be configured as illustrated at FIGS. 17, 17A and 17AA with a spinner bolt flange 58 and ptfe cryogenic cold gasket 13 as previously described to form a leak-free seal 79.

### ANOTHER ILLUSTRATIVE EMBODIMENT

FIG. 21 illustrates another embodiment of a discharge system configured as a capped roof termination 166 which may be incorporated into an MRI machine quench system 200 as disclosed herein. The MRI machine quench vent system 200 as shown is comprised of prefabricated chimney duct sections 70 illustrating multiple changes in direction 206 with a capped roof termination 166 at a discharge location 202 on the top of a roof 5. FIG. 21A is a side view of the illustrative MRI machine quench vent system 200 disclosed at FIG. 21. FIG. 21B is a detailed side view of a capped roof termination 166.

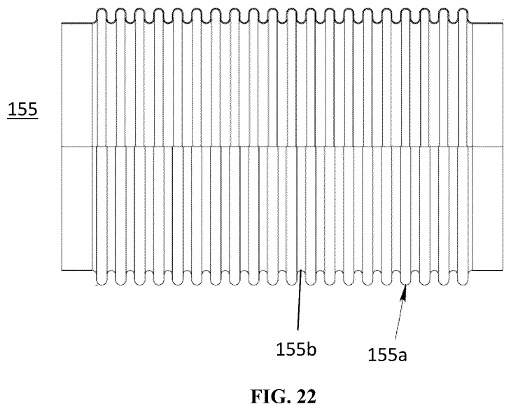

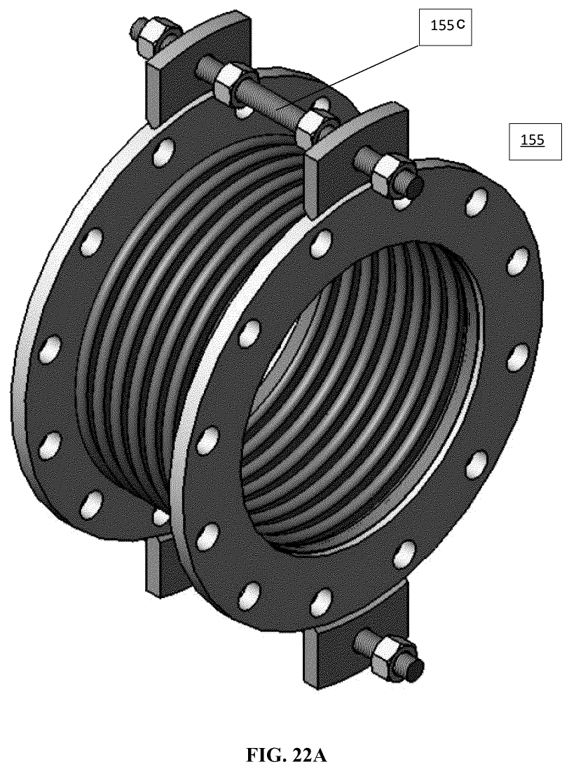

FIG. 22 is a side view of at least one embodiment of a bellows section 155 which may be incorporated into an MRI quench vent system 200 as disclosed herein. Without limitation or restriction, the bellows section 155 is configured as a 10 inch×18 inch single expansion joint. The outside diameter of the bellows section (155a) is 11.25 inches and the outside diameter of the skirt (155b) is 10.09 inches. One of ordinary skill will appreciate that the bellows section 155 shown at FIG. 22 is for illustration only and is shown without an inner shell flange 55a having a rim 55b. In at least one embodiment, the bellows section 155 is configured with at least one end adapted for connection with another section of prefabricated chimney duct (71, 72) for an insulated chimney system 70 with an inner shell spinner bolt flange/inner shell rim interface 75 as illustrated in FIGS. 17-19. As disclosed at FIG. 22A, bellows sections 155 may include tie rods 155c suitable for a particular system to limit axial movement to ensure that the bellows sections 155 does not overextend and exert an extreme amount of force on the system in a high-pressure vent situation. The use of tie rods 155c may be necessary in particular systems to ensure that the bellows sections 155 do not squirm or bulge in a way that will cause the MRI quench vent system to shift or move in an undesired way during pressure testing or other high-pressure circumstances. Further, for at least one embodiment, bellows sections 155 without tie rods, as shown at FIG. 22, may be suitable for particular applications without departure from the spirit and intent of the disclosure. Accordingly, the specific apparatus, as well as components, and/or method selected in no way limits the scope of the present disclosure unless so indicated in the following claims.

FIG. 23 is a perspective view of an illustrative quench vent system 200 comprised of prefabricated chimney duct sections 70 illustrating multiple changes in direction 206 and a discharge cone 167 for the termination exiting through a wall 6 to an exterior area or space 4 at discharge location 202. FIG. 23A is a side view of the illustrative quench vent system 200 comprised of prefabricated chimney duct sections 70 as disclosed at FIG. 23. FIG. 23B is a detailed side view of a discharge cone 167 as shown in FIGS. 23 and 23A which may be incorporated into an MRI quench vent system 200 as disclosed herein. FIGS. 23-23B illustrate at least one embodiment of a discharge system configured as a cone 167 which may be incorporated into an MRI quench vent system 200 as disclosed herein.

FIG. 24 illustrates another embodiment of a termination for an MRI machine quench vent system 200 configured as a box discharge 168 which may be used with chimney duct system in the preceding FIGS. 21-23 without departure from the scope of this disclosure. FIG. 22 illustrates another embodiment of a discharge system configured as an MRI Box Discharge 167 which may be incorporated into an MRI quench vent system 200 as disclosed herein.

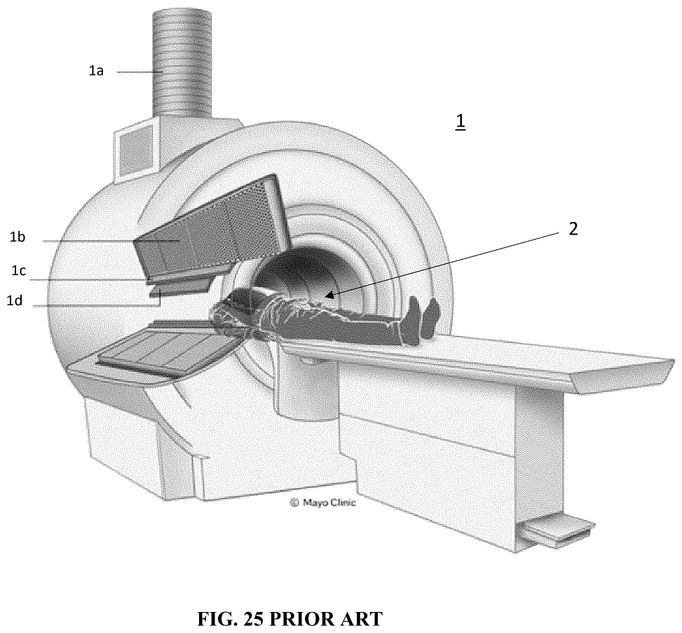

FIG. 25 is an illustrative perspective view of an MRI machine including the quench vent outlet as known in the prior art. The image is included herein for educational purposes only copyright Mayo Clinic.

FIG. 26 is an operating graph for a low temperature insulation suitable for at least one embodiment of an MRI machine quench vent joint system using the prefabricated chimney ducts 200 as disclosed herein.

Table 2 provides performance characteristics for a cryogenic insulation disclosed herein for purposes of enablement of at least one embodiment of an MRI quench vent system 200 assembled using the prefabricated chimney sections 70 and joint seal methods and systems disclosed throughout and further as disclosed in Appendices B and C, which are incorporated by reference herein. As disclosed, the cryogenic insulation may be used as suitable for any particular application requiring insulation 80 or an insulation strip 81, including for an MRI machine quench vent joint seal system 200, as disclosed in FIGS. 17-26 and may be positioned in the insulation gap 78.

TABLE 2
PERFORMANCE PROPERTIES OF CRYOGENIC INSULATION

| Material | |
|---|---|
| Operating Temperature, ° F. (° C.) | −450 (−268)-450 (232) |
| Thickness, in (mm) | 1(25) |
| Density, pcf (kg/m3) | 1(16) |

Product Availability

| Standard Product Sizes | |
|---|---|
| Standard Roll - Width, in (mm) | 72.0 (1828.8) |
| Standard Roll - Length, ft (m) | 50.0 (15.2) |
| Weight - Net, lbs (kg) | 25.1 (11.4) |

The method of assembling the weld-free MRI machine quench vent system 200 comprises selecting an MRI machine quench vent outlet 1a. FIG. 20 is a flow chart useful for at least one method of configuring and assembling a MRI machine quench vent system 200 comprised of prefabricated chimney duct sections 70 for various routes and terminations. As shown at FIG. 26 the quench vent outlet 1a is typically located on the exterior of the MRI machine extending vertically from the top of the MRI machine 1. The MRI machine 1 is typically located in a protected and secured interior structure, such as a hospital treatment center. A discharge location 202 for venting the quench gas is then selected. As understood by those knowledgeable in this field, the discharge location 202 is typically an area exterior of the interior structure 4. However, in some applications, the discharge location 202 may also be located in an interior area, particularly if the termination 165 selected is a discharge box 168 for use as a quench vent gas diffuser. As the helium gas vented from the MRI machine 1 during a quench event undergoes rapid expansion and is (or approaches) −452.4 degrees Fahrenheit, the discharge location 202 must allow for safe discharge to protect people and property.

FIG. 20 is a flowchart illustrating a method in step 300 for configuring and assembling a weld-free MRI machine quench vent system 200 from pre-fabricated chimney duct components 70, according to at least one embodiment. At step 300, the selection of an MRI machine quench vent outlet 1a may be initiated. This selection may involve identifying the starting point for venting, which is typically located on the exterior of the MRI machine 1, extending vertically from the top. The MRI machine is generally situated within a protected and secured interior structure, such as a hospital treatment center. The selection of the quench vent outlet may be significant for determining the initial point of the venting process. The process may then proceed to step 302 the selection of a discharge location 202, which may be an area exterior to the interior structure, allowing for the safe discharge of helium gas vented during a quench event. The discharge location 202 may also be an interior area if a discharge box 168 is used as a diffuser. The selection of the discharge location 202 may be vital for ensuring the safe venting of the quench gas, which undergoes rapid expansion and approaches extremely low temperatures. The method may further involve mapping a route at step 304 between the MRI machine quench vent outlet 1a and the discharge location 202. This mapped route 204 may include sections or components in both horizontal and vertical planes, as well as transitions between these planes. The generated route 204 may be analyzed to determine if there is a change in direction, either vertically or horizontally at step 306. For each change in direction 206, at least one elbow 160 may be selected to facilitate the transition at step 308. If a horizontal change in direction is required, at least one bellows section 160 may be selected to compensate for thermal contraction at step 310.

(See FIGS. 21 and 23) The distance between the MRI machine and the discharge location May be calculated at step 312 to determine the positioning of supports 150 for the chimney duct 70.

These supports 150, which may include plates 151, hangers 152, and full rings 153, may be positioned to ensure proper support and reliability of the vent system 200 at step 314. The method may culminate at step 316 in the assembly of a plurality of prefabricated chimney duct sections 70, which are connected according to the mapped route 204 to fluidly connect the MRI machine vent outlet 1a to the termination 165 at the discharge location 202. The prefabricated duct sections 70 may be configured with a spinner bolt flange 58 and a PTFE cryogenic cold gasket 13 to ensure secure connections and leak prevention via a leak-free seal 79. The assembly process may result in a weld-free MRI machine quench vent system 200 that is capable of safely venting quench gas from the MRI machine to the selected discharge location.

In the context of configuring and assembling a weld-free MRI machine quench vent system 200, the process may involve selecting a discharge location 202. This step may be significant as it determines where the quench gas will be vented, ensuring safety and compliance with environmental and structural requirements. The discharge location 202 may typically be an area exterior to the interior structure housing the MRI machine, such as a hospital treatment center. However, in certain applications, the discharge location may also be situated within an interior area, particularly if a discharge box is used as a diffuser. The selection of the discharge location may take into account the rapid expansion and extremely low temperature of the helium gas vented during a quench event, which can approach −452.4 degrees Fahrenheit. Therefore, the discharge location must allow for safe discharge to protect people and property. The selection process may involve identifying components and determining the starting point for venting, as indicated by the actions associated with the discharge location. This step may be part of a broader method of generating a weld-free MRI machine quench vent discharge system from pre-fabricated chimney duct components.

In step 304, the process of mapping a route between the MRI machine quench vent outlet and the discharge location may be initiated. This step may involve generating a route 204 that connects the MRI machine quench vent outlet 1a to the discharge location 202. The route 204 may be designed to accommodate sections or components that are generally in the horizontal plane, sections or components that are generally in the vertical plane, and sections or components that transition from one plane to the other. The mapping of the route may be important to ensure that the quench vent system 200 can effectively channel the vented helium gas from the MRI machine to the designated discharge location. The generated route may be further analyzed to determine if there are any changes in direction, either in the vertical or horizontal plane. This analysis may be necessary to identify the need for additional components, such as elbow sections, to facilitate the change in direction. The mapping process may also consider the potential need for bellows sections to compensate for thermal contraction in the quench vent system. The route mapping may be a key step in ensuring that the quench vent system is configured to safely and efficiently discharge the helium gas, protecting both people and property.

At step 306, the determination of whether the route has a change in direction in either a vertical or horizontal direction may be undertaken. This step may involve assessing the generated route to identify any transitions between different planes. The route, which connects the MRI machine quench vent outlet to the discharge location, may require careful analysis to ensure that any changes in direction are accounted for. The determination of direction changes may be important for the subsequent selection of components that facilitate these transitions. The route May include sections that are generally in the horizontal plane, sections that are generally in the vertical plane, and sections that transition from one plane to the other. This analysis may be necessary for ensuring that the quench vent system can accommodate the physical layout of the installation site. The determination of direction changes may also influence the selection of elbow sections and bellows sections, which are components that may be used to manage changes in direction and thermal contraction, respectively. The elbow sections may be necessary for each change in direction, and the bellows sections may be required for horizontal changes in direction or to compensate for thermal contraction. This step may be integral to the overall configuration and assembly of the weld-free MRI machine quench vent system, ensuring that the system is capable of safely and effectively venting quench gas from the MRI machine to the discharge location.

In the context of configuring a weld-free MRI machine quench vent discharge system, the process may involve selecting at least one elbow for each change in direction determined along the route between the MRI machine quench vent outlet and the discharge location. This step may be important in accommodating the spatial constraints and ensuring the efficient flow of quench gases. The elbow sections may be chosen based on the specific angles required to navigate the route, which may include thirty, forty-five, or ninety-degree bends. These elbow sections may be configured as prefabricated chimney ducts, which may include an inner shell spinner bolt flange and an inner shell rim interface. This configuration may facilitate secure connections and maintain the integrity of the vent system. The selection of elbow sections may also consider the need to handle thermal contraction, which may be addressed by incorporating bellows sections if horizontal changes in direction are present. The bellows sections may be positioned strategically to compensate for thermal expansion and contraction, ensuring the system's reliability under varying temperature conditions. The integration of these components may contribute to the overall functionality and safety of the MRI machine quench vent discharge system, allowing for the effective discharge of quench gases while minimizing the risk of leaks or structural failures.

In the context of step 310, the process may involve the selection of at least one bellows section if a horizontal change in direction is required within the MRI machine quench vent discharge system. The bellows section may be chosen to accommodate any necessary adjustments in the horizontal plane, potentially due to the layout of the route or the structural requirements of the system. The bellows section may serve to handle thermal contraction, which can occur due to the high-pressure, low-temperature conditions associated with the quench vent system. This selection process may be necessary to ensure the integrity and functionality of the vent system, allowing for flexibility and movement without compromising the system's performance. The bellows section may be installed between sections of the prefabricated chimney duct, providing a means to absorb and compensate for any thermal expansion or contraction that may occur. This installation may be essential for maintaining a secure and leak-free connection between the duct sections, ensuring the safe and efficient discharge of quench gases from the MRI machine. The bellows section may be configured to work in conjunction with other components, such as elbows, to facilitate changes in direction and maintain the overall structural integrity of the vent system. The selection and installation of the bellows section may be guided by the specific requirements of the system, including the calculated distance between the MRI machine and the discharge location, as well as the need for support and securement of the duct sections. This process may involve careful consideration of the system's design and operational parameters to ensure optimal performance and safety.

At step 312, the process may involve calculating a calculated distance between the MRI machine and the discharge location. This calculation may be necessary for determining the appropriate positioning of supports for the MRI machine quench vent discharge system. The calculated distance may serve as a key parameter in ensuring that the vent system is adequately supported throughout its length. The supports, which may include hangers, plates, full rings, or other suitable components, may be positioned based on this calculated distance to provide stability and reliability to the vent system. The positioning of these supports may be important in maintaining the structural integrity of the system, especially given the potential for thermal contraction and expansion due to the extreme temperatures involved in the quench process. The calculated distance may also inform the selection and placement of other components, such as bellows sections, which may be necessary to accommodate changes in direction or to compensate for thermal contraction. The overall goal of this step may be to ensure that the vent system is both functional and secure, with all components properly aligned and supported according to the calculated distance.

In the context of step 314, the process may involve determining a position for at least one support for engagement with the MRI machine quench vent discharge system based on the calculated distance. The calculated distance between the MRI machine and the discharge location may be used to ascertain the optimal positioning of supports. These supports, which may include hangers, full rings, plates, or combinations thereof, can be strategically positioned to ensure the structural integrity and reliability of the chimney duct system. The supports may be affixed to the chimney duct sections by welding or other securement methods suitable for the application. The positioning of supports may be influenced by the specific conditions of the installation environment, such as the length of the duct sections and the need for stability under high-pressure, low-temperature conditions. The supports may be positioned at regular intervals, such as every twelve feet, to provide consistent support throughout the system. This step May ensure that the quench vent system is adequately supported, thereby facilitating the safe and efficient discharge of quench gases from the MRI machine.

At step 316, the assembly of a plurality of prefabricated chimney ducts 70 may be undertaken to establish a connection according to the mapped route between the MRI machine quench vent outlet 1a and the termination located at the selected discharge location. This process may involve configuring the first inner shell, which may include a first end configured with an inner shell rim, a second end also configured with an inner shell rim, and a body portion having an axial length that connects the first and second ends. The first inner shell spinner bolt flange may be configured as a collar with an interior designed to surround the exterior of the first inner shell.

The exterior face of this flange may have a plurality of apertures positioned around its perimeter, and it may contact and abut the inner shell rim at the first end. Similarly, a second inner shell spinner bolt flange may be configured to surround the exterior of the inner shell, with its exterior face also having multiple apertures around its perimeter, and it may contact and abut the inner shell rim at the second end.

A gasket 13 may be positioned between the second inner shell spinner bolt flange of a first prefabricated chimney duct section and the abutting first inner shell spinner bolt flange of a second prefabricated chimney section. This gasket may have a plurality of apertures 13a around its perimeter and may be composed of polytretrafluoroethylene (PTFE), suitable for a temperature range of −452.4 degrees F. to 100 degrees F. A plurality of fasteners may be inserted into and through the aligned apertures of the gasket and the apertures of the second inner shell spinner bolt flange of the first chimney duct section, as well as the apertures of the first inner shell spinner bolt flange of the second section, to secure the connection of the adjacent prefabricated chimney duct sections.

The prefabricated chimney duct section may include a tubular outer shell designed to surround the inner shell of the prefabricated chimney duct section. An L-shaped clip may be positioned between the inner shell and the outer shell to create an insulation gap, where an insulating material may be positioned. This configuration may contribute to forming an insulated chimney system, which may be necessary for the effective and safe operation of the MRI machine quench vent discharge system.

As previously discussed, and illustrated at least by FIGS. 20-26 herein, after the discharge location 202 is selected, a route 204 for connecting the MRI machine quench vent outlet 1a to the discharge location 202 is generated. One of ordinary skill will appreciate that the generated route 204 may have sections or components generally in the horizontal plane, sections or components generally in the vertical plane and sections or components which transition from one plane to the other. The termination 165 for the MRI machine quench vent system 200 is selected based on the discharge location 202 selected and the generated chimney duct route 204. A termination 165 for use with a roof-top (generally in the horizontal plane) which is shown at FIGS. 21, 21A and 21B is known as a capped roof termination 166.

FIG. 21B provides a detailed view of a capped roof termination 166. As illustrated at FIGS. 21 and 21A, the chimney duct 70 connected to the capped roof termination 166 is generally orientated in the vertical plane to extend vertically up and through the roof-top 7 of the interior space 3. A termination 165 for use with a chimney duct system 70 generally in the horizontal plane and extending into and through a vertical wall is illustrated at FIGS. 22 and 22A. In at least one embodiment, the terminations 165 are configured with at least one end adapted for connection with another section of prefabricated chimney duct for an insulated chimney system with an inner shell spinner bolt flange/inner shell rim interface 75 as illustrated in FIGS. 17-19.

In at least one illustrative embodiment, the distance between the MRI machine 1 and the discharge location 202 is calculated to further determine where supports 150 for the chimney duct 70 for the vent system 200 are to be positioned. For purposes of illustration only, a support 150 may be positioned every twelve (12) feet as suitable for a particular application. Positioning supports 150 more or less frequently may be suitable for other conditions without departure from the scope of the present disclosure. A suitable support 150 may be selected from plates 151, hangers 152 and full rings 153, as shown in FIGS. 21-23B, or combinations therein. The supports 150 may be affixed to the chimney duct sections 70 by welding or any other methods of securement suitable for a particular application for proper support and reliability, without limitation or restriction. The generated route 204 should be further analyzed to determine if the generated route 204 has a change in direction 206 in the horizontal plane. See FIG. 21 and FIG. 23. An elbow section 160 is necessary for each change in direction and illustrative elbow sections 160, without limitation or restriction, may include thirty (30), forty-five (45) and ninety (90) degree bends. In at least one embodiment, the elbow sections 160 are configured as prefabricated chimney ducts for an insulated chimney system 70 with an inner shell spinner bolt flange/inner shell rim interface 75 as illustrated in FIGS. 17-19.

Each change in direction 206 in the horizontal plane may require installation of at least one bellows section 155. In at least one embodiment, a bellows section 155 may also be required by the length of a particular section of the chimney duct 70. For purposes of illustration only, a bellows section 155 is positioned every thirty (30) feet. Positioning a bellows section 155 between chimney duct sections 70 more or less frequently may be suitable for other conditions without departure from the scope of the present disclosure. In at least one embodiment, the bellows section 155 is used to compensate for thermal contraction in the quench vent system 200 composed of prefabricated chimney duct sections (71/72) which are subject to high-pressure, low temperature applications. In at least one embodiment, not shown but understood, a termination 165 may be positioned directly above (in the vertical plane) the MRI machine quench vent outlet 1a. In this particular embodiment, no bellows section 155 would be required. A quench vent system 200 is assembled by then connecting a plurality of prefabricated chimney duct sections 70 to fluidly connect the MRI machine vent outlet 1a to the termination 165 according to the generated route 204. In at least one embodiment, the prefabricated duct sections 70 may be configured as illustrated at FIGS. 17, 17A and 17AA with a spinner bolt flange and ptfe cryogenic cold gasket 13 as previously described.

The preceding constraints, examples, and configurations in any of the aspects of the present systems & methods disclosed and described herein are for illustrative purposes only, and are in no way limiting to the scope of any of the systems and/or methods as disclosed herein unless so indicated in the following claims. Furthermore, the various solutions, processes, methods, modules, features, aspects, and/or embodiments disclosed or described herein may be implemented in conjunction with one another or independently from one another. Accordingly, the presence or absence of other subject matter that may be complementary to the present systems and/or methods in no way limits the scope of the present systems and/or methods unless so indicated in the following claims.

It should be noted that the present systems and/or methods are not limited to the specific embodiments described herein, but is intended to apply to all similar systems and/or methods for mitigating and/or eliminating leakage between two adjacent duct sections. Modifications and alterations from the described embodiments will occur to those skilled in the art without departure from the spirit and scope of the present systems and/or methods.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit of the present disclosure. Other embodiments will be apparent to those skilled in the art from consideration of the specification and practice disclosed herein. It is intended that the specification and examples be considered as illustrative only, with a true scope and spirit being indicated by the following claims.

1. A prefabricated chimney duct system comprising:
a) a first prefabricated chimney duct section comprising:
i) a first inner shell, the first inner shell further comprising:
1. a first end configured with an inner shell rim;
2. a second end, the second end configured with an inner shell rim;
3. a body portion having an axial length, the body portion connecting the first end and the second end;
ii) a first inner shell spinner bolt flange configured as a collar with an interior to surround the exterior of the first inner shell and an exterior face having a plurality of apertures positioned in and around a perimeter of the exterior face and wherein the first inner shell spinner bolt flange contacts and abuts the inner shell rim at the first end; and,
iii) a second inner shell spinner bolt flange configured as a collar with an interior to surround the exterior of the inner shell and an exterior face having a plurality of apertures positioned in and around a perimeter of the exterior face and wherein the second inner shell spinner bolt flange contacts and abuts the inner shell rim at the second end;
b) a second prefabricated chimney duct section comprising:
i) an inner shell, the inner shell further comprising:
1. a first end configured with an inner shell rim;
2. a second end, the second end configured with an inner shell rim;
3. a body portion having an axial length, the body portion connecting the first end and the second end;
ii) a first inner shell spinner bolt flange configured as a collar with an interior to surround the exterior of the inner shell and an exterior face having a plurality of apertures positioned in and around a perimeter of the exterior face and wherein the first inner shell spinner bolt flange contacts and abuts the inner shell rim at the first end; and,
iii) a second inner shell spinner bolt flange configured as a collar with an interior to surround the exterior of the inner shell and an exterior face having a plurality of apertures positioned in and around a perimeter of the exterior face and wherein the second inner shell spinner bolt flange contacts and abuts the inner shell rim at the second end;
c) a leak-free joint connecting the first prefabricated chimney duct section and the second prefabricated chimney duct section, the leak-free joint further comprising:
i) a gasket having a plurality of apertures, the gasket positioned between the second inner shell spinner bolt flange of the first prefabricated chimney duct section and the abutting first inner shell spinner bolt flange of the second prefabricated chimney section, wherein the apertures of the gasket and the apertures of the second inner shell spinner bolt flange of the first prefabricated chimney duct section and the apertures of the first inner shell spinner bolt flange of the second prefabricated chimney duct section are aligned, wherein the gasket is comprised of polytretrafluoroethylene (PTFE) and suitable for a temperature range of −452.4 degrees F. to 100 degrees F.
ii) a plurality of fasteners inserted into and through the aligned apertures of the gasket and the apertures of the second inner shell spinner bolt flange of the first chimney duct section and the apertures of the first inner shell spinner bolt flange of the second section; and,
iii) wherein the first and second inner shell spinner bolt flanges are rotatable around the perimeter of the inner shell and movable along the axial dimension of the intermediate portion of the inner shell and wherein a first gasket having a plurality of apertures is affixed to the face of the first inner shell spinner bolt flange.

2. The prefabricated chimney duct system according to claim 1 wherein a second gasket having a plurality of apertures is affixed to the face of the second inner shell spinner bolt flange.

3. The prefabricated chimney duct system according to claim 1 wherein a tubular outer shell surrounds the inner shell of either the first prefabricated chimney duct section or the second prefabricated chimney duct section.

4. The prefabricated chimney duct system according to claim 2 wherein a tubular outer shell surrounds the inner shell of the first prefabricated chimney duct section and the second prefabricated chimney duct section.

5. The prefabricated chimney duct system according to claim 4 wherein an l-shaped clip is positioned between the inner shell and the outer shell to create an insulation gap.

6. The prefabricated chimney duct system according to claim 5 wherein an insulating material is positioned in the insulation gap.

7. The prefabricated chimney duct system according to claim 1 comprised of multiple adjacent chimney sections to form a modular prefabricated leak-free chimney system with a temperature rating of −452.4 degrees F. to 100 degrees F.

8. The prefabricated chimney duct system according to claim 7 rated for static pressures of up to 10 PSIG.

9. The prefabricated chimney duct section according to claim 1 wherein the first inner shell spinner bolt flange of the first prefabricated chimney duct section is connected to a MRI machine to create a quench vent exhaust.

10. The prefabricated chimney duct section according to claim 10 comprised of multiple adjacent chimney sections to form a modular prefabricated leak-free chimney system with a temperature rating of −452.4 degrees F. to 100 degrees F.

11. The prefabricated chimney duct section according to claim 10 wherein a gasket is positioned adjacent the first inner shell spinner bolt flange of the first prefabricated chimney duct section.

12. The prefabricated chimney duct section according to claim 3 wherein the first inner shell spinner bolt flange of the first prefabricated chimney duct section is connected to a MRI machine to create a quench vent exhaust.

13. The prefabricated chimney duct section according to claim 6 wherein the first inner shell spinner bolt flange of the first prefabricated chimney duct section is connected to a MRI machine to create a quench vent exhaust.

14. The prefabricated chimney duct section according to claim 8 wherein the first inner shell spinner bolt flange of the first prefabricated chimney duct section is connected to a MRI machine to create a quench vent exhaust.

15. A method of assembling a prefabricated chimney duct system comprising:
a) positioning a first prefabricated chimney duct section for connection, the first prefabricated chimney duct section further comprising:
i) a first inner shell, the first inner shell further comprising:
1. a first end configured with an inner shell rim;
2. a second end, the second end configured with an inner shell rim;
3. a body portion having an axial length, the body portion connecting the first end and the second end;
ii) a first inner shell spinner bolt flange configured as a collar with an interior to surround the exterior of the first inner shell and an exterior face having a plurality of apertures positioned in and around a perimeter of the exterior face and wherein the first inner shell spinner bolt flange contacts and abuts the inner shell rim at the first end; and,
iii) a second inner shell spinner bolt flange configured as a collar with an interior to surround the exterior of the inner shell and an exterior face having a plurality of apertures positioned in and around a perimeter of the exterior face and wherein the second inner shell spinner bolt flange contacts and abuts the inner shell rim at the second end;
b) positioning a second prefabricated chimney duct section adjacent to the first prefabricated chimney duct section, the second prefabricated chimney further comprising:
i) an inner shell, the inner shell further comprising:
1. a first end configured with an inner shell rim;
2. a second end, the second end configured with an inner shell rim;
3. a body portion having an axial length, the body portion connecting the first end and the second end;
ii) a first inner shell spinner bolt flange configured as a collar with an interior to surround the exterior of the inner shell and an exterior face having a plurality of apertures positioned in and around a perimeter of the exterior face and wherein the first inner shell spinner bolt flange contacts and abuts the inner shell rim at the first end; and,
iii) a second inner shell spinner bolt flange configured as a collar with an interior to surround the exterior of the inner shell and an exterior face having a plurality of apertures positioned in and around a perimeter of the exterior face and wherein the second inner shell spinner bolt flange contacts and abuts the inner shell rim at the second end;
c) positioning a gasket between the second inner shell spinner bolt flange of the first prefabricated chimney duct section and the abutting first inner shell spinner bolt flange of the second prefabricated chimney section, wherein a plurality of apertures are positioned around a perimeter of the gasket;
d) aligning the apertures of the second inner shell spinner bolt flange of the first chimney duct section and the apertures of the first inner shell spinner bolt flange of the second section with the plurality of apertures of the gasket via rotation; and,
e) inserting a plurality of fasteners into and through the aligned apertures of the gasket and the apertures of the second inner shell spinner bolt flange of the first chimney duct section and the apertures of the first inner shell spinner bolt flange of the second section to create a leak-free joint connecting the first prefabricated chimney duct section and the second prefabricated chimney duct section.

16. The method of assembling a prefabricated chimney duct system according to claim 16 wherein the first inner shell spinner bolt flange and the second first inner shell spinner bolt flange of the first chimney duct section and the second chimney duct section are rotatable around the perimeter of the inner shell for improved aligning of the apertures of the second inner shell spinner bolt flange of the first chimney duct section and the apertures of the first inner shell spinner bolt flange of the second section with the plurality of apertures of the gasket prior to insertion of the plurality of fasteners.

17. The method of assembling a prefabricated chimney duct system according to claim 16 further configured with a tubular outer shell to surround the inner shell of the first prefabricated chimney duct section and the second prefabricated chimney duct section, wherein an l-shaped clip is positioned between the inner shell and the outer shell to create an insulation gap wherein an insulating material is positioned in the insulation gap.

18. The method of assembling a prefabricated chimney duct system according to claim 15 wherein the gasket is comprised of polytretrafluoroethylene (PTFE) and suitable for a temperature range of −452.4 degrees F. to 100 degrees F.

19. The prefabricated chimney duct section according to claim 17 wherein the first inner shell spinner bolt flange of the first prefabricated chimney duct section is connected to a MRI machine to create a quench vent exhaust.
